(19) United States
(12) Patent Application Publication
(10) Pub. No.: US 2006/0066590 A1
(43) Pub. Date: Mar. 30, 2006

(54) Input device

(76) Inventors: Masanori Ozawa, Kawasaki-shi (JP); Katsumi Hisano, Matsudo-shi (JP); Ryo Furukawa, Kawasaki-shi (JP); Minoru Mukai, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/236,611

(22) Filed: Sep. 28, 2005

(30) Foreign Application Priority Data
Sep. 29, 2004 (JP) P2004-285453

(51) Int. Cl. G09G 5/00

(52) U.S. Cl. 345/173

(57) ABSTRACT

An input device includes a display unit indicating an image which represents an input position; a contact position detecting unit detecting a position of an object brought into contact with a contact detecting surface of the display unit; a memory storing data representing a difference between the detected position and a center of the image which represents the input position; and an arithmetic unit calculating an amount for correcting the image which represents the input position on the basis of the data stored by the memory.

### CROSS REFERENCE TO RELATED APPLICATIONS

This application is based upon and claims the benefit of priority from prior Japanese Patent Application 2004-285453 filed on Sep. 29, 2004 the entire contents of which are incorporated by reference herein.

### BACKGROUND OF THE INVENTION

1. Field of the Invention

The present invention relates to an input device feeds information into a computer or the like.

2. Description of the Related Art

Usually, an interface for a computer terminal includes a keyboard and a mouse as an input device, and a cathode ray tube (CRT) or a liquid crystal display (LCD) as a display unit.

Further, so-called touch panels in which a display unit and an input device are laminated one over another are in wide use as interfaces for computer terminals, small portable tablet type calculators, and so on.

Japanese Patent Laid-Open Publication No. 2003-196,007 discloses a touch panel used to enter characters into a portable phone or a personal digital assistant (PDA) which has a small front surface.

However, with the related art, a contact position of the object such as a finger tip or an input pen on a touch panel often deviates from a proper position because a palm sizes or an eyeshot varies between individuals.

The present invention is aimed at overcoming the foregoing problem of the related art, and provides an input device which can appropriately detect a contact position by an object.

### BRIEF SUMMARY OF THE INVENTION

According to a first aspect of the embodiment, there is provided an input device including: a display unit indicating an image which represents an input position; a contact position detecting unit detecting a position of an object brought into contact with a contact detecting surface of the display unit; a memory storing data representing a difference between the detected position and a center of the image which represents the input position; and an arithmetic unit calculating an amount for correcting the image which represents the input position on the basis of the data stored by the memory.

In accordance with a second aspect, there is provided a microcomputer including: a display unit indicating an image which represents an input position; a contact position detecting unit detecting a position of an object brought into contact with a contact detecting surface of the display unit; a memory storing data representing a difference between the detected position and a center of the image which represents the input position; an arithmetic unit calculating an amount for correcting the image which represents the input position on the basis of the data stored by the memory; a contact position detecting unit detecting a position of an object brought into contact with a contact detecting layer provided on a display layer of the display unit; and a processing unit which performs processing in accordance with the detected contact state of the object and information entered into the input device.

According to a third aspect, there is provided a microcomputer including a memory storing a difference between a contact position of an object onto a contact detecting surface of a display unit indicating an image which represents an input position and a center of the image which represents the input position; an arithmetic unit calculating a correction amount of the image the input position on the basis of the data stored in the memory; and a processing unit which performs processing in accordance with the detected contact state of the object.

In accordance with a fourth aspect, there is provided an information processing method including: indicating an image which represents an input position on a display unit; detecting a contact position of the object in contact with a contact detecting surface of the display unit; storing a difference between the detected position and a center of then image which represents the input position; calculating an amount for correcting the image which represents the input position on the basis of the stored data; and indicating the corrected image on the display unit.

According to a final aspect, there is provided an information processing program enabling an input information processor to: indicate an image for recognizing an input position on a display unit; detect a contact position of an object brought into contact on a contact detecting surface of display unit; store data concerning a difference between the detected position and a center of the image which represents the input position; calculate an amount for correcting the image which represents the input position on the basis of the stored data; and indicate the corrected image which represents the input position.

### BRIEF DESCRIPTION OF THE SEVERAL THE DRAWINGS

FIG. 1 is a perspective view of a portable microcomputer according to a first embodiment of the invention;

FIG. 2 is a perspective view of an input section of the portable microcomputer;

FIG. 3A is a perspective view of a touch panel of the portable microcomputer;

FIG. 3B is a top plan view of the touch panel of FIG. 3A;

FIG. 3C is a cross section of the touch panel of FIG. 3A;

FIG. 4 is a block diagram showing a configuration of an input device of the portable microcomputer;

FIG. 5 is a block diagram of the portable microcomputer;

FIG. 6 is a graph showing variations of a size of a contact area of an object brought into contact with the touch panel;

FIG. 7 is a graph showing variation of a size of a contact area of an object brought into contact with the touch panel in order to enter information;

FIG. 8A is a perspective view of a touch panel converting pressure into an electric signal;

FIG. 8B is a top plan view of the touch panel shown in FIG. 8A;

FIG. 8C is a cross section of the touch panel;

FIG. 9 is a schematic diagram showing the arrangement of contact detectors of the touch panel;

FIG. 10 is a schematic diagram showing contact detectors detected when they are pushed by a mild pressure;

FIG. 11 is a schematic diagram showing contact detectors detected when they are pushed by an intermediate pressure;

FIG. 12 is a schematic diagram showing contact detectors detected when they are pushed by an intermediate pressure;

FIG. 13 is a schematic diagram showing contact detectors detected when they are pushed by a large pressure;

FIG. 14 is a schematic diagram showing contact detectors detected when they are pushed by a largest pressure;

FIG. 15 is a perspective view of a lower housing of the portable microcomputer;

FIG. 16 is a top plan view of an input device of the portable microcomputer, showing that user's palms are placed on the input device in order to enter information;

FIG. 17 is a top plan view of the input device, showing that the user's fingers hit keys;

FIG. 18 is a flowchart of information processing steps conducted by the input device;

FIG. 19 is a flowchart showing details of step S106 shown in FIG. 18;

FIG. 20 is a flowchart of further information processing steps conducted by the input device;

FIG. 21 is a flowchart showing details of step S210 shown in FIG. 20;

FIG. 22 shows hit section of a key top of the input device;

FIG. 23 shows a further example of hit section of the key top of the input device;

FIG. 24 is a flowchart showing an automatic adjustment process;

FIG. 25 is a flowchart showing a further automatic adjustment process;

FIG. 26 is a flowchart showing a typing practice process;

FIG. 27 is a graph showing a key hit ratio during the typing practice process;

FIG. 28 is a flowchart showing an automatic adjustment process during retyping;

FIG. 29 is a flowchart showing a mouse using mode;

FIG. 30A shows a state in which the user is going to use the mouse;

FIG. 30B shows the mouse;

FIG. 31 shows an eyesight correcting process;

FIG. 32 shows a further eyesight calibrating process;

FIG. 33 shows a still further eyesight calibrating process;

FIG. 34 is a flowchart showing the eyesight calibrating process;

FIG. 35 shows an off-the-center key hit amount;

FIG. 36 shows off-the-center key hit states;

FIG. 37 shows a size of contact area;

FIG. 38 is a graph showing variations of the size of the contact area in x direction;

FIG. 39 is a graph showing variations of the size of the contact area in y direction;

FIG. 40 is a flowchart showing a further eyesight calibrating process;

FIG. 41 is a perspective view of an input device of a further embodiment;

FIG. 42 is a block diagram of an input device in a still further embodiment;

FIG. 43 is a block diagram of an input device in a still further embodiment;

FIG. 44 is a block diagram of a still further embodiment; and

FIG. 45 is a perspective view of a touch panel of a final embodiment.

### DETAILED DESCRIPTION OF THE INVENTION

Various embodiments of the present invention will be described with reference to the drawings. It is to be noted that the same or similar reference numerals are applied to the same or similar parts and elements throughout the drawings, and the description of the same or similar parts and element will be omitted or simplified.

### First Embodiment

In this embodiment, the invention relates to an input device, which is a kind of an input-output device of a terminal unit for a computer.

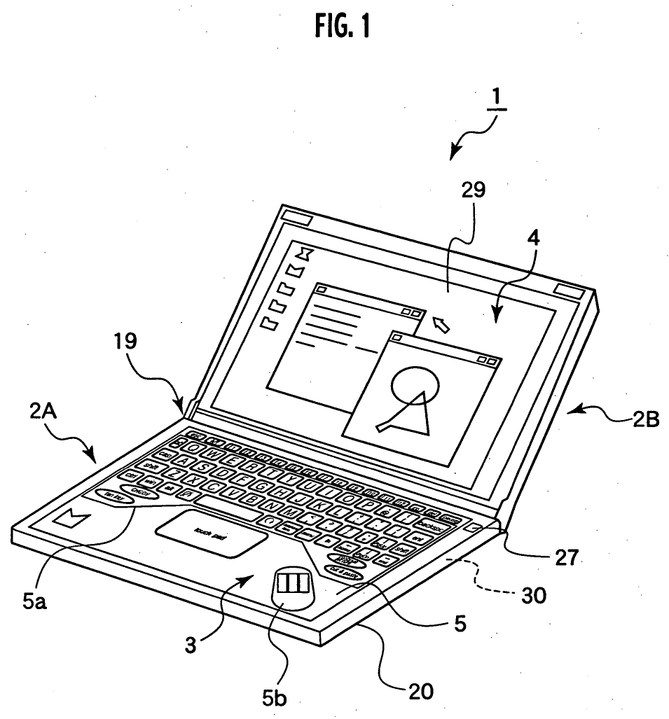

Referring to FIG. 1, a portable microcomputer 1 (called the “microcomputer 1”) comprises a computer main unit 30, a lower housing 2A and an upper housing 2B. The computer main unit 30 includes an arithmetic and logic unit such as a central processing unit. The lower housing 2A houses an input unit 3 as a user interface for the computer main unit 30. The upper housing 2B houses a display unit 4 with a liquid crystal display panel 29 (called the “display panel 29”).

The computer main unit 30 uses the central processing unit in order to process information received via the input unit 3. The processed information is indicated on the display unit 4 in the upper housing 2B.

The input unit 3 in the lower housing 2A includes a display unit 5, and a detecting unit which detects a contact state of an object (such as a user's finger or an input pen) onto a display panel of the display unit 5. The display unit 5 indicates images informing a user of an input position, e.g., keys on a virtual keyboard 5a, a virtual mouse 5b, various input keys, left and right buttons, scroll wheels, and so on which are used for the user to input information.

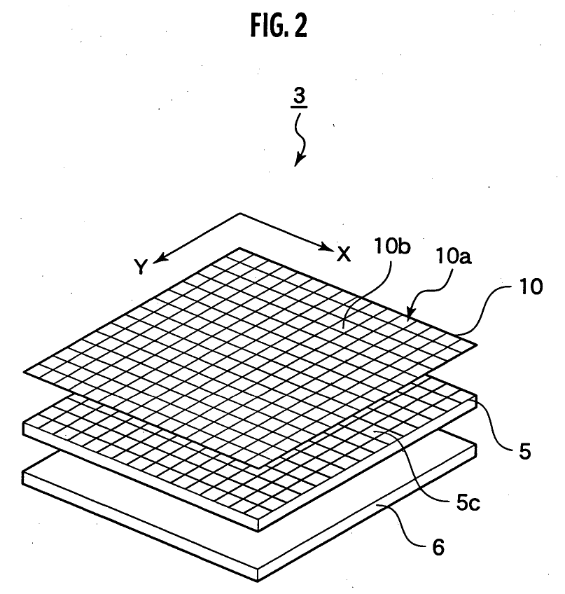

The input unit 3 further includes a backlight 6 having a light emitting area, and a touch panel 10 laminated on the display unit 5, as shown in FIG. 2. Specifically, the display unit 5 is laminated on the light emitting area of the backlight 6.

The backlight 6 may be constituted by a combination of a fluorescent tube and an optical waveguide which is widely used for displays of microcomputers, or may be realized by a plurality of white light emitting diodes (LED) arranged on the flat. Such LEDs have been recently put to practical use.

Both the backlight 6 and the display unit 5 may be structured similarly to those used for display units of conventional microcomputers or those of external LCD displays for desktop computers. If the display unit 5 is light emitting type, the backlight 6 may be omitted.

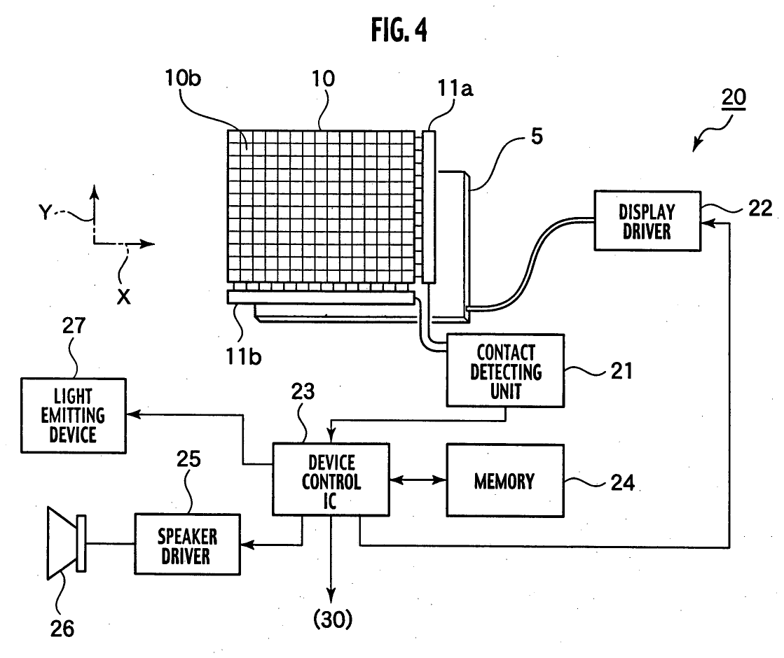

The display unit 5 includes a plurality of pixels 5c arranged in x and y directions and in the shape of a matrix, is actuated by a display driver 22 (shown in FIG. 4), and indicates an image which represents the input position such as the keyboard or the like.

The touch panel 10 is at the top layer of the input unit 3, is exposed on the lower housing 2A, and is actuated in order to receive information. The touch panel 10 detects an object (the user's finger or input pen) which is brought into contact with a detecting layer 10a.

In the first embodiment, the touch panel 10 is of a resistance film type. Analog and digital resistance film type touch panels are available at present. Four- to eight-wire type analog touch panels are in use. Basically, parallel electrodes are utilized, a potential of a point where the object comes into contact with an electrode is detected, and coordinates of the contact point are derived on the basis of the detected potential. The parallel electrodes are independently stacked in X and Y directions, which enables X and Y coordinates of the contact point to be detected. However, with the analog type, it is very difficult to simultaneously detect a number of contact points. Further, the analog touch panel is inappropriate for detecting dimensions of the contact areas. Therefore, the digital touch panel is utilized in the first embodiment in order to detect both the contact points and dimensions of the contact areas. In any case, the contact detecting layer 10a is transparent, so that the display unit 5 is visible from the front side.

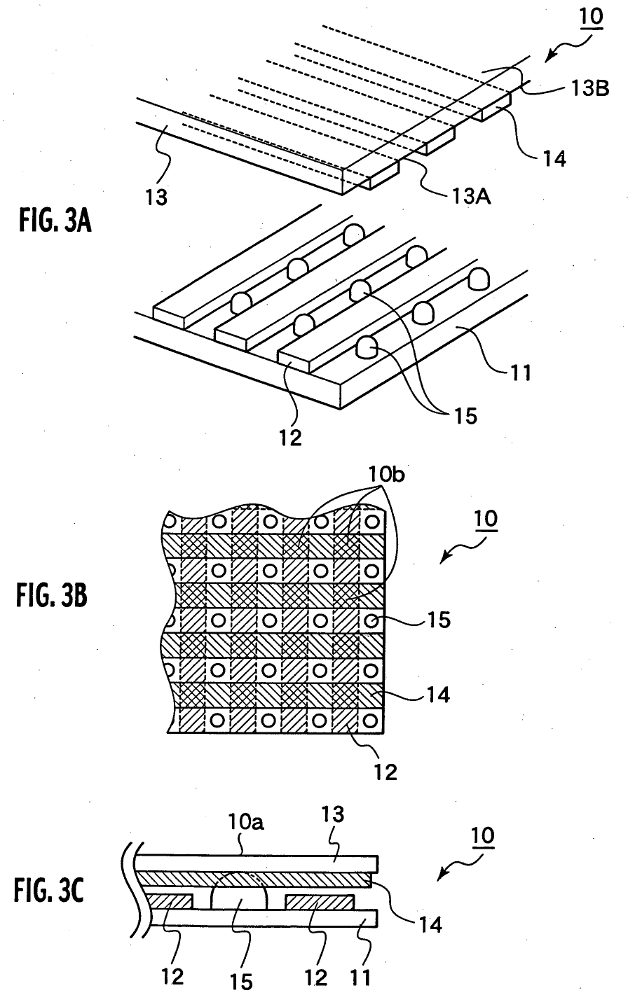

Referring to FIG. 3A and 3B, the touch panel 10 includes a base 11 and a base 13. The base 11 includes a plurality (n) of strip-shaped X electrodes 12 which are arranged at regular intervals in the X direction. On the other hand, the base 13 includes a plurality (m) of strip-shaped Y electrodes 14 which are arranged at regular intervals in the Y direction. The bases 11 and 13 are stacked with their electrodes facing with one another. In short, the X electrodes 12 and Y electrodes 14 are orthogonal to one another. Therefore, (n×m) contact detectors 10b are arranged in the shape of a matrix at the intersections of the X electrodes 12 and Y electrodes 14.

A number of convex-curved dot spacers 15 are provided between the X electrodes on the base 11. The dot spacers 15 are made of an insulating material, and are arranged at regular intervals. The dot spacers 15 have a height which is larger than a total of thickness of the X and Y electrodes 12 and 14. The dot spacers 15 have their tops brought into contact with exposed areas 13A of the base 13 between the Y electrodes 14. As shown in FIG. 3C, the dot spacers 15 are sandwiched by the bases 11 and 13, and are not in contact with the X and Y electrodes 12 and 14. In short, the X and Y electrodes 12 and 14 are out of contact with one another by the dot spacers 15. When the base 13 is pushed in the foregoing state, the X and Y electrodes 12 and 14 are brought into contact with one another.

The surface 13B of the base 13, opposite to the surface where the Y electrodes are mounted, is exposed on the lower housing 2A, and is used to enter information. In other words, when the surface 13B is pressed by the user's finger or the input pen, the Y electrode 14 is brought into contact with the X electrode 12.

If a pressure applied by the user's finger or input pen is equal to or less than a predetermined pressure, the base 13 is not sufficiently flexed, which prevents the Y electrode 14 and the X electrode 12 from being brought into contact with each other. Only when the applied pressure is above the predetermined value, the base 13 is fully flexed, so that the Y electrode 14 and the X electrode 12 are in contact with each other and become conductive.

The contact points of the Y and X electrodes 14 and 12 are detected by the contact detecting unit 21 (shown in FIG. 4) of the input unit 3.

With the microcomputer 1, the lower housing 2A houses not only the input unit 3 (shown in FIG. 1) but also the input device 20 (shown in FIG. 4) which includes contact detecting unit 21 detecting contact points of the X and Y electrodes 12 and 14 of the touch panel 10 and recognizing a shape of an object in contact with the touch panel 10.

Referring to FIG. 2 and FIG. 4, the input device 20 includes the input unit 3, the contact detecting unit 21, a device control IC 23, a memory 24, a speaker driver 25, and a speaker 26. The device control IC 23 converts the detected contact position data into digital signals and performs I/O control related to various kinds of processing (to be described later), and communications to and from the computer main unit 30. The speaker driver 25 and speaker 26 are used to issue various verbal notices or a beep sound for notice.

The contact detecting unit 21 applies a voltage to the X electrodes 12 one after another, measures voltages at the Y electrodes 14, and detects a particular Y electrode 14 which produces a voltage equal to the voltage applied to the X electrodes.

The touch panel 10 includes a voltage applying unit 11a, which is constituted by a power source and a switch part. In response to an electrode selecting signal from the contact detecting unit 21, the switch part sequentially selects X electrodes 12, and the voltage applying unit 11a applies the reference voltage to the selected X electrodes 12 from the power source.

Further, the touch panel 10 includes a voltage meter 11b, which selectively measures voltages of Y electrodes 14 specified by electrode selecting signals from the contact detecting unit 21, and returns measured results to the contact detecting unit 21.

When the touch panel 10 is pressed by the user's finger or input pen, the X and Y electrodes 12 and 14 at the pressed position come into contact with each other, and become conductive. The reference voltage applied to the X electrode 12 is measured via the Y electrode 14 where the touch panel 10 is pressed. Therefore, when the reference voltage is detected as an output voltage of the Y electrode 14, the contact detecting unit 21 can identify the Y electrode 14, and the X electrode 12 which is applied the reference voltage. Further, the contact detecting unit 21 can identify the contact detector 10b which has been pressed by the user's finger or input pen on the basis of a combination of the X electrode 12 and Y electrode 14.

The contact detecting unit 21 repeatedly and quickly detects contact states of the X and Y electrodes 12 and 14, and accurately detects a number of the X and Y electrodes 12 and 14 which are simultaneously pressed, depending upon arranged intervals of the X and Y electrodes 12 and 14.

For instance, if the touch panel 20 is strongly pressed by the user's finger, a contact area is enlarged. The enlarged contact area means that a number of contact detectors 10b are pressed. In such a case, the contact detecting unit 21 repeatedly and quickly applies the reference voltage to X electrodes 12, and repeatedly and quickly measures voltages at Y electrodes 14. Hence, it is possible to detect the contact detectors 10b pressed at a time. The contact detecting unit 21 can detect a size of the contact area on the basis of detected contact detectors 10b.

In response to a command from the device control IC 23, the display driver 22 indicates one or more images of buttons, icons, keyboard, ten-keypad, mouse and so on which are used as input devices, i.e., user's interface. Light emitted by the backlight 6 passes through the LCD from a back side thereof, so that the images on the display unit 5 can be observed from the front side.

The device control IC 23 identifies an image of the key at the contact point on the basis of a key position on the virtual keyboard (indicated on the display unit 5) and the contact position and a contact area detected by the contact detecting unit 21. Information on the identified key is notified to the computer main unit 30.

The computer main unit 30 controls operations for the information received from the device control IC 23.

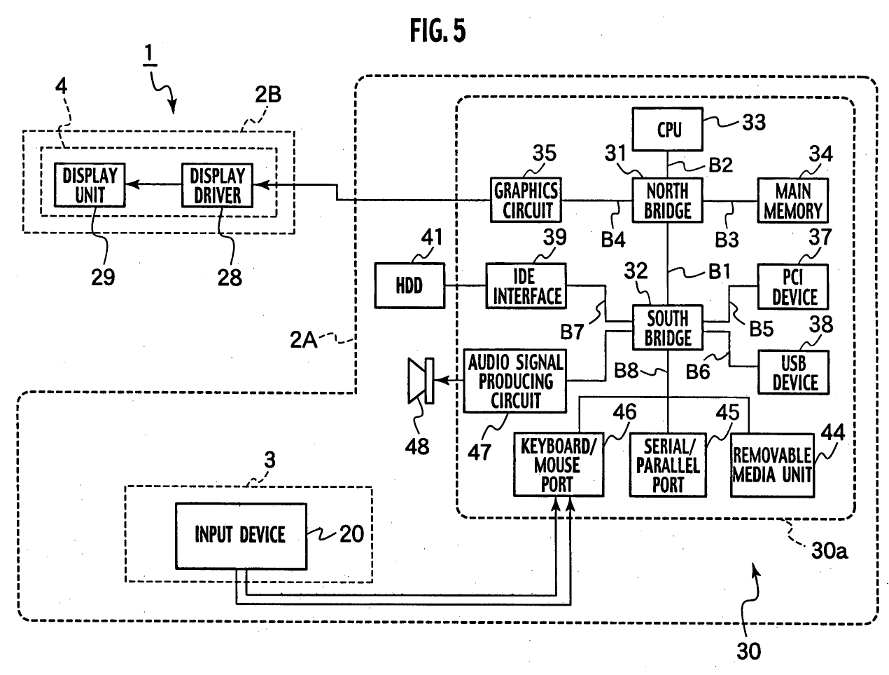

Referring to FIG. 5, in a motherboard 30a (functioning as the computer main unit 30), a north bridge 31 and a south bridge 32 are connected using a dedicated high speed bus B1. The north bridge 31 connects to a central processing unit 33 (called the “CPU 33”) via a system bus B2, and to a main memory 34 via a memory bus B3, and to a graphics circuit 35 via an accelerated graphics port bus B4 (called the “AGP bus B4”).

The graphics circuit 35 outputs a digital image signal to a display driver 28 of the display panel 4 in the upper housing 2B. In response to the received signal, the display driver 28 actuates the display panel 29. The display panel 29 indicates an image on a display panel (LCD) thereof.

Further, the south bridge 32 connects to a peripheral component interconnect device 37 (called the “PCI device 37”) via a PCI bus B5, and to a universal serial bus device 38 (called the “USB device 38”) via a USB bus B6. The south bridge 32 can connect a variety of units to the PCI bus 35 via the PCI device 37, and connect various units to the USB device 38 via the USB bus B6.

Still further, the south bridge 32 connects to a hard disc drive 41 (called the “HDD 41”) via an integrated drive electronics interface 39 (called the “IDE interface 39”) and via an AT attachment bus B7 (called the “ATA bus 37”). In addition, the south bridge 32 connects via a low pin count bus B8 (called the “LCP bus B8”) to a removable media device (magnetic disc device) 44, a serial/parallel port 45 and a keyboard/mouse port 46. The keyboard/mouse port 46 provides the south bridge 32 with a signal received from the input device 20 and indicating the operation of the keyboard or the mouse. Hence, the signal is transferred to the CPU 33 via the north bridge 31. The CPU 33 performs processing in response to the received signal.

The south bridge 32 also connects to an audio signal output circuit 47 via a dedicated bus. The audio signal output circuit 47 provides an audio signal to a speaker 48 housed in the computer main unit 30. Hence, the speaker 48 outputs variety of sounds.

The CPU 33 executes various programs stored in the HDD 41 and the main memory 34, so that images are shown on the display panel 29 of the display unit 4 (in the upper housing 2B), and sounds are output via the speaker 48 (in the lower housing 2A). Thereafter, the CPU 33 executes operations in accordance with the signal indicating the operation of the keyboard or the mouse from the input device 20. Specifically, the CPU 33 controls the graphics circuit 35 in response to the signal concerning the operation of the keyboard or the mouse. Hence, the graphics circuit 35 outputs a digital image signal to the display unit 5, which indicates an image corresponding to the operation of the keyboard or the mouse. Further, the CPU 33 controls the audio signal output circuit 47, which provides an audio signal to the speaker 48. The speaker 48 outputs sounds indicating the operation of the keyboard or the mouse. Hence, the CPU33 (the processor) is designed to execute a variety of processes in response to the operation data of the keyboard and mouse outputted from the input device 20 (shown in FIG. 4).

Refer to FIG. 4, the following describe how the input device 20 operates in order to detect contact states of the finger or input pen on the contact detecting layer 10a.

The contact detecting unit 21 (as a contact position detecting unit) periodically detects a position where the object is in contact with the contact detecting layer 10a of the touch panel 10, and provides the device control IC 23 with the detected results.

The contact detecting unit 21 (as a contact strength detector) detects contact strength of the object on the contact detecting layer 10a. The contact strength may be represented by two, three or more discontinuous values or a continuous value. The contact detecting unit 21 periodically provides the device control IC 23 with the detected strength.

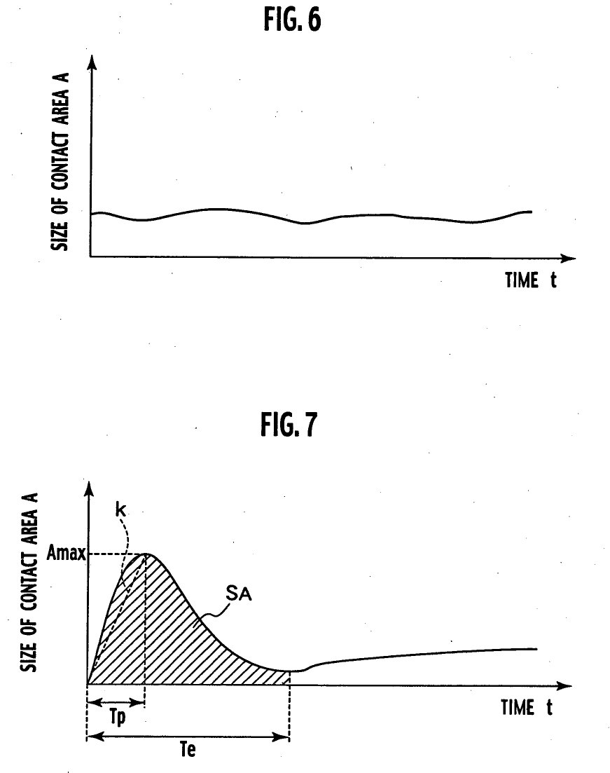

The contact strength can be detected on the basis of the sizes of the contact area of the object on the contact detecting layer 10a, or time-dependent variations of the contact area. FIG. 6 and FIG. 7 show variations of sizes of the detected contact area. In these figures, the ordinate and abscissa are dimensionless, and neither units nor scales are shown. Actual values may be used at the time of designing the actual products.

The variations of the contact area will be derived by periodically detecting data on the sizes of contacts between the object and the contact detector 10b using a predetermined scanning frequency. The higher the scanning frequency, the more signals will be detected in a predetermined time period. Resolutions can be more accurately improved with time. For this purpose, reaction speeds and performance of the devices and processing circuits have to be improved. Therefore, an appropriate scanning frequency will be adopted.

Specifically, FIG. 6 shows an example in which the object is simply in contact with the contact detecting layer 10a, i.e. the user simply places his or her finger without aim to key. The size of the contact area A do not change sharply.

On the contrary, FIG. 7 shows another example in which a size of the contact area A varies when a key is hit on the keyboard on the touch panel 10. In this case, the size of the contact area A is quickly increased from 0 or substantially 0 to a maximum, and then quickly is reduced.

The contact strength may be detected on the basis of a contact pressure of the object onto the contact detecting layer 10a, or time-dependent variations of the contact pressure. In this case, a sensor converting the pressure into an electric signal may be used as the contact detecting layer 10a.

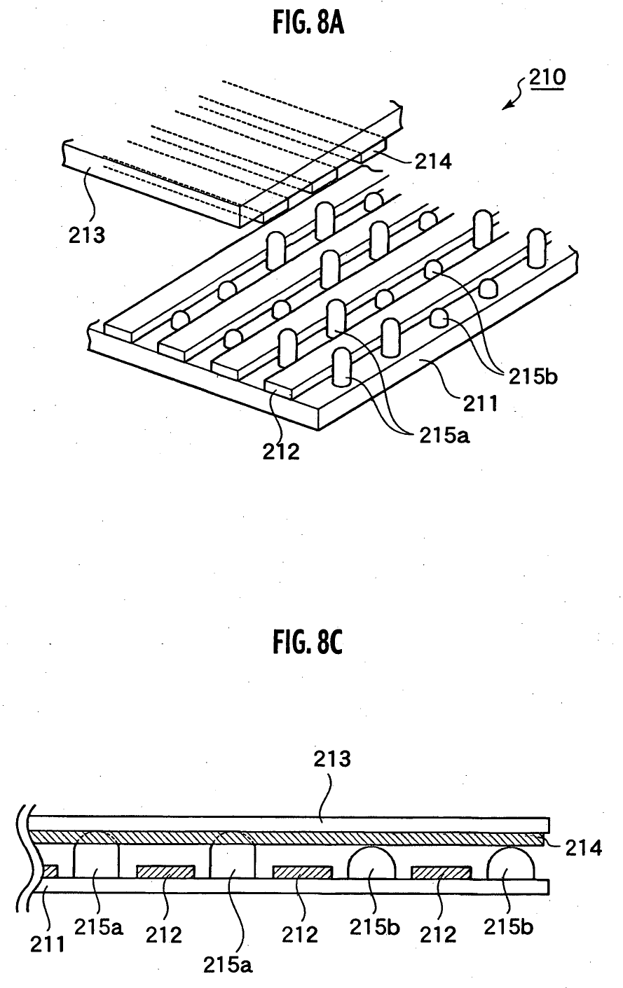

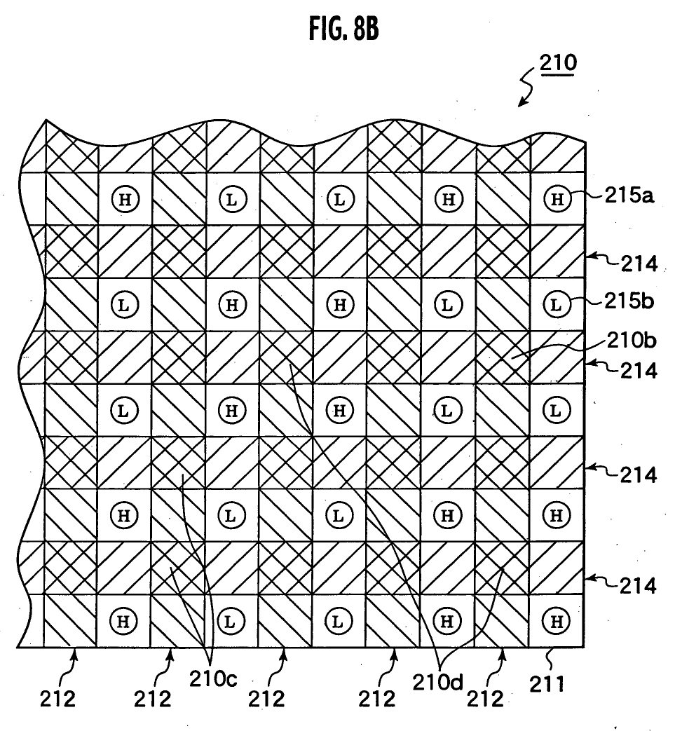

FIG. 8A and FIG. 8B show a touch panel 210 as a sensor converting the pressure into an electric signal (called a contact strength detector).

Referring to these figures, the touch panel 210 comprises a base 211 and a base 213. The base 211 is provided with a plurality of (i.e., n) transparent electrode strips 212 serving as X electrodes (called the “X electrodes 212”) and equally spaced in the direction X. The base 213 is provided with a plurality of (i.e., m) transparent electrode strips 214 serving as Y electrodes (called the “Y electrodes 214”) and equally spaced in the direction Y. The bases 211 and 213 are stacked with the X and Y electrodes 212 and 214 facing one another. Hence, (n×m) contact detectors 210b to 210d are present in the shape of a matrix at intersections of the X and Y electrodes 212 and 214.

Further, a plurality of dot spacers 215 are provided between the X electrodes 212 on the base 211, and have a height which is larger than a total thickness of the X and Y electrodes 212 and 214. The tops of the dot spacers 215 are in contact with the base 213 exposed between the Y electrodes 214.

Referring to FIG. 8A, in a dot spacer 215, four tall dot spacers 215a constitute one group, and four short dot spacers 215b constitute one group. Groups of the four tall dot spacers 215a and groups of the four short dot spacers 215b are arranged in a reticular pattern, as shown in FIG. 8B. The number of toll dot spacers 215a per group and that of short dot spacers 215b per group can be determined as desired.

Referring to FIG. 8C, the dot spacers 215 are sandwiched between the bases 211 and 213. Hence, X and Y electrodes 212 and 214 are not in contact with one another. Therefore, the contact detectors 210b to 210e are electrically in an off-state.

The X and Y electrodes 212 and 214 are in an on-state when the base 213 is flexed while the foregoing electrodes are not in contact with one another.

With the touch panel 210, the surface 213A which is opposite to the surface of the base 213 where the Y electrodes 214 are positioned is exposed as an input surface. When the surface 213A is pressed by the user's finger, the base 213 is flexed, thereby bringing the Y electrode 214 into contact with the X electrode 212.

If pressure applied by the user's finger is equal to or less than a first predetermined pressure, the base 213 is not sufficiently flexed, which prevents the X and Y electrodes 214 and 212 from coming into contact with each other.

Conversely, when the applied pressure is above the first predetermined pressure, the base 213 is sufficiently flexed, so that a contact detector 210b surrounded by four low dot spacers 215b (which are adjacent to one another without via the Y and X electrodes 214 and 212) is in the on-state. The contact detectors 210c and 210d surrounded by two or more high dot spacers 215a remain in the off-state.

If the applied pressure is larger than a second predetermined pressure, the base 213 is further flexed, the contact detector 210c surrounded by two low dot spacers 215b is in the on-state. However, the contact detector 210d surrounded by four high dot spacers 215a remain in the off-state.

Further, if the applied pressure is larger than a third predetermined pressure which is larger than the second pressure, the base 213 is more extensively flexed, so that the contact detector 210d surrounded by four high dot spacers 215a is in the on-state.

The three contact detectors 210b to 210d are present in the area pressed by the user's finger, and function as sensors converting the detected pressures into three kinds of electric signals.

With the portable microcomputer including the touch panel 210, the contact detecting unit 21 detects which contact detector is in the on-state.

For instance, the contact detecting unit 21 detects a contact detector, which is surrounded by a group of adjacent contact detectors in the on-state, as a position where the contact detecting surface 10a is pressed.

Further, the contact detecting unit 21 ranks the contact detectors 210b to 210d in three grades, and a largest grade is output as pressure, among a group of adjacent contact detectors in the on-state.

The contact detecting unit 21 detects a contact area and pressure distribution as follows.

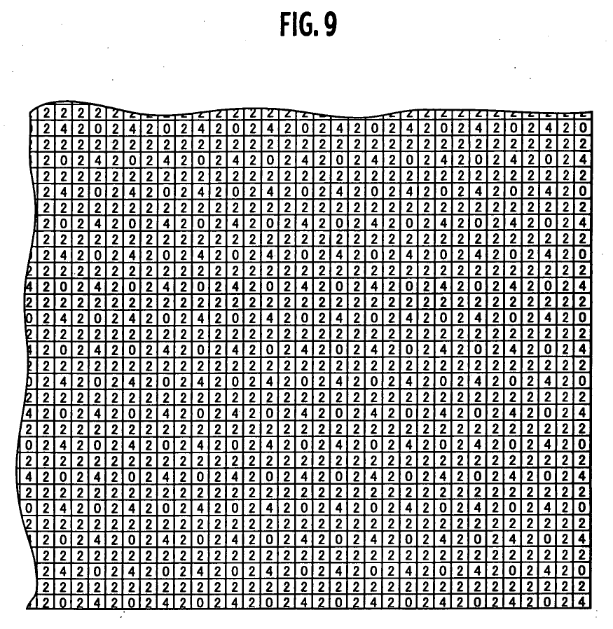

When the low and high dot spacers 215b and 215a shown in FIG. 8B are arranged as shown in FIG. 9, each contact detector 210 is surrounded by four dot spacers. In FIG. 9, numerals represent the number of the high dot spacers 215a at positions corresponding to the contact detectors 210a to 210d.

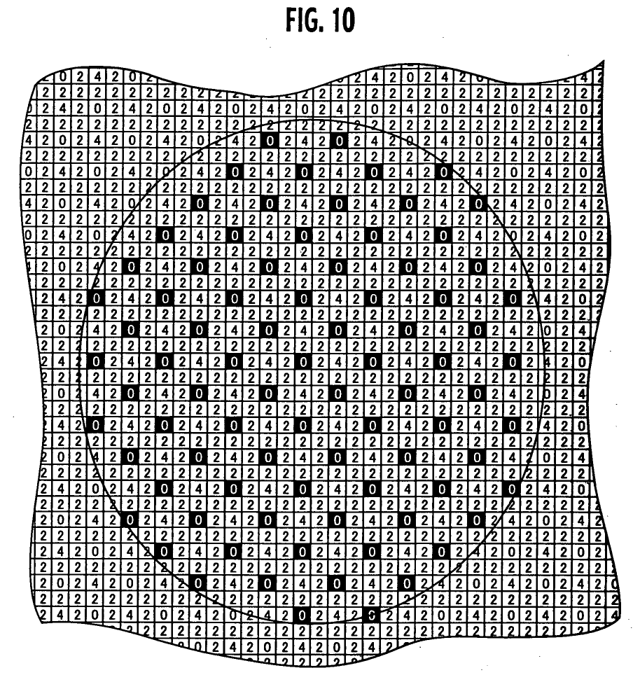

In FIG. 10, an oval shows an area contacted by the user's finger, and is called the “outer oval”.

When a surface pressure of the contact area (i.e., pressure per unit area) is simply enough to press contact detectors shown by “0”, the contact detecting unit 21 detects that only contact detectors “0” (i.e., the contact detectors 210b shown in FIG. 8B) are pressed.

If much stronger pressure is applied to an area whose size is the same as that of the outer oval compared to the pressure shown in FIG. 9, the contact detecting unit 21 detects contact detectors “2” existing in an oval inside (called the “inner oval”) the outer oval, i.e., contact detectors 210c shown in FIG. 8B are pressed.

The larger the pressure, the larger the outer oval as described with reference to the operation principle of the embodiment. However, it is assumed that the outer oval has a constant size for explaining easily.

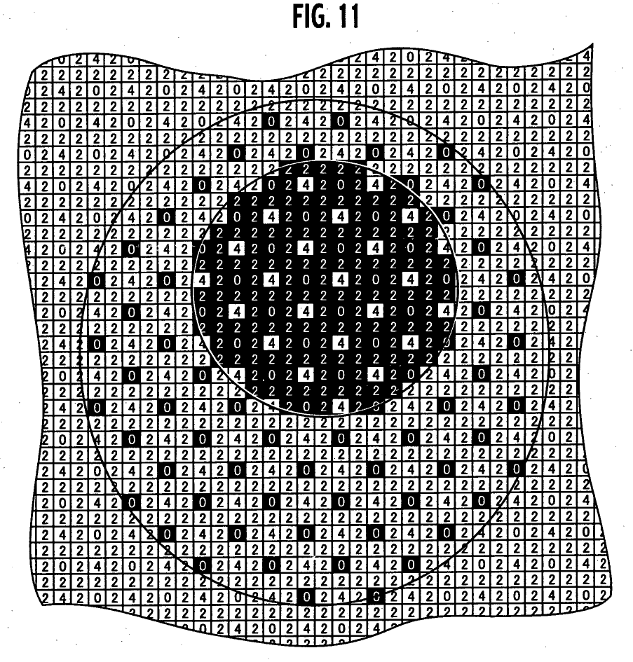

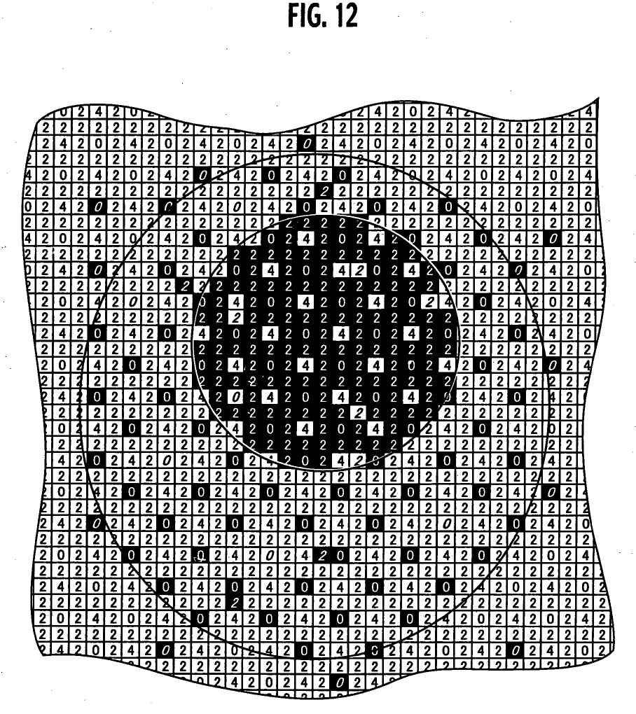

However, the surface pressure is not always actually distributed in the shape of an oval as shown in FIG. 11. In FIG. 12, some contact detectors outside the outer oval may be detected to be pressed, and some contact detectors “0” or “2” inside the inner oval may not be detected to be pressed. Those exception are described in italic digits in FIG. 12. In short, contact detectors “0” and “2” are mixed near a border of the outer and inner ovals. The border, size, shape or position of the outer and inner ovals are determined so as to reduce errors caused by these factors. In such a case, the border of the outer and inner ovals may be complicated in order to assure flexibility. However, the border is actually shaped with an appropriate radius of curvature. This enables the border to have a smoothly varying contour and is relatively free from errors. The radius of curvature determined through experiments, machine learning algorithm or the like. Objective functions are a size of an area surrounded by the outer oval and inner oval at the time of keying, a size of an area surrounded by the inner oval and an innermost oval, and a time-dependent keying identifying error rate. A minimum the radius of curvature is determined in order to minimize the foregoing parameters.

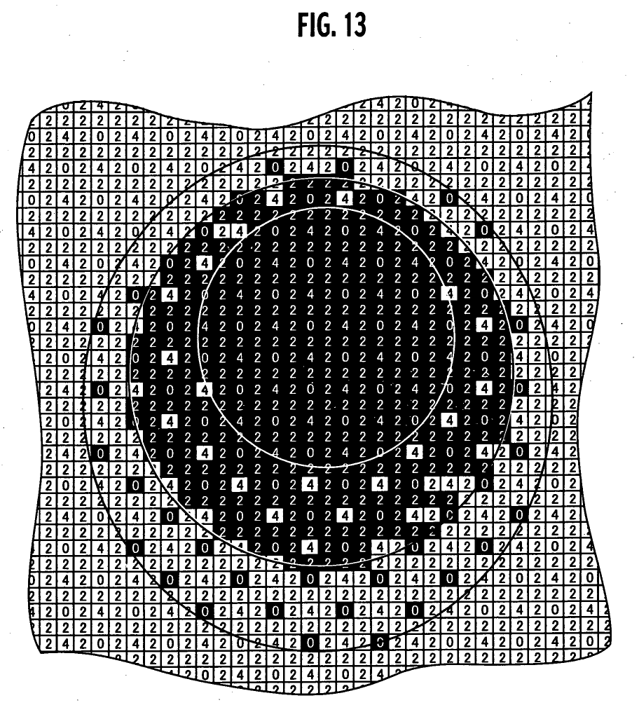

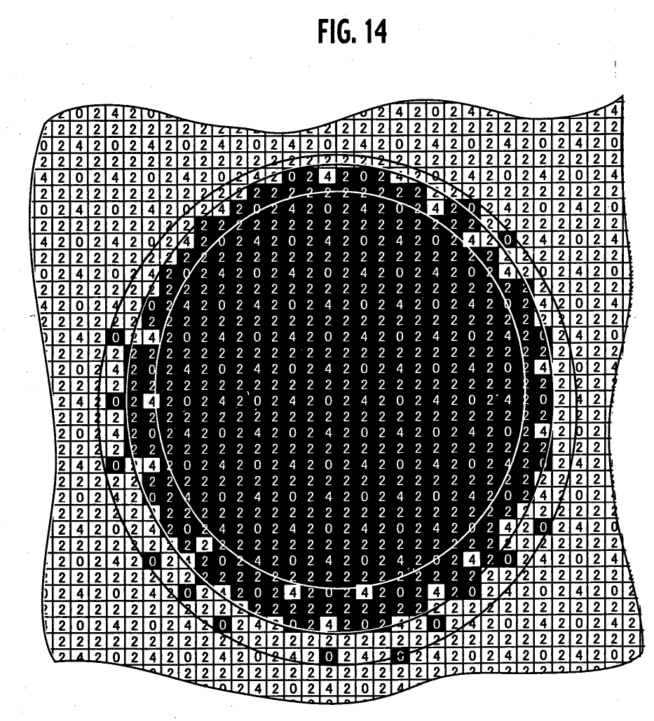

The border determining method mentioned above is applicable to the cases shown in FIG. 10, FIG. 11, FIG. 13 and FIG. 14.

FIG. 13 shows that much stronger pressure than that shown in FIG. 11 is applied. In this case, an innermost oval appears inside the inner oval. In the second inner oval, the contact detectors shown by “0”, “2” and “4” are detected to be pressed, i.e., the contact detectors 210b, 210c and 210d shown in FIG. 8B are pressed.

Referring to FIG. 14, the sizes of the inner oval and innermost oval are enlarged. This means that pressure which is further larger than that of FIG. 13 is applied.

It is possible to reliably detect whether the user intentionally or unintentionally depresses a key or keys by detecting time dependent variations of the sizes of the ovals and time-dependent variations of a size ratios of the ovals, as shown in FIG. 10, FIG. 11, FIG. 13 and FIG. 14.

For instance, the sensor converting the pressure into the electric signal is used to detect the contact pressure of the object onto the contact detecting surface 10a or contact strength on the basis of time-dependent variations of the contact pressure. If the ordinates in FIG. 6 and FIG. 7 are changed to “contact pressure”, the same results will be obtained with respect to “simply placing the object” and “key hitting”.

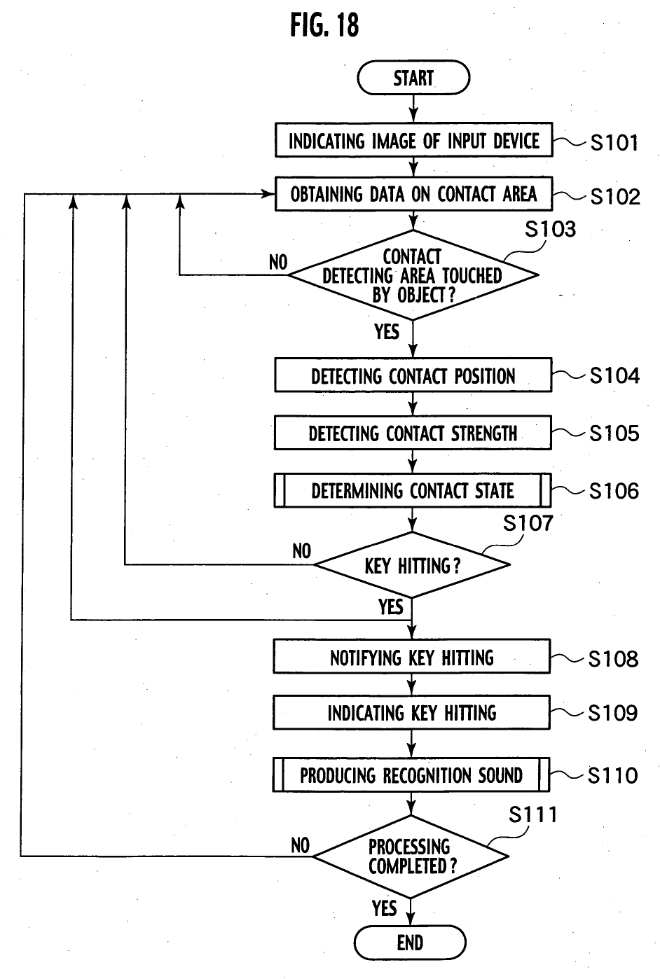

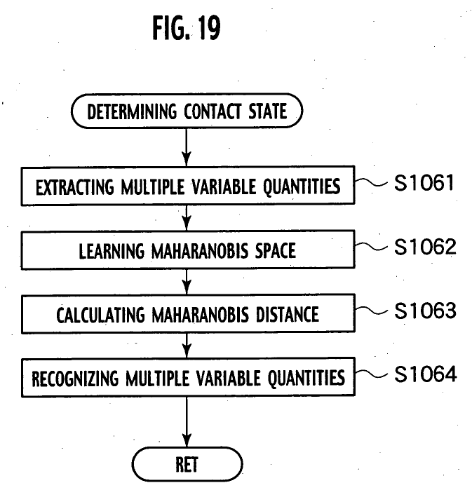

The device control IC 23 (as a determining section) receives the contact strength detected by the contact detecting unit 21, extracts a feature quantity related to the contact strength, compares the extracted feature quantity or a value calculated based on the extracted feature quantity with a predetermined threshold, and determines a contact state of the object. The contact state may be classified into “non-contact”, “contact” or “key hitting”. “Non-contact” represents that nothing is in contact with an image on the display unit 5; “contact” represents that the object is in contact with the image on the display unit 5; and “key hitting” represents that the image on the display unit 5 is hit by the object. Determination of the contact state will be described later in detail with reference to FIG. 18 and. FIG. 19.

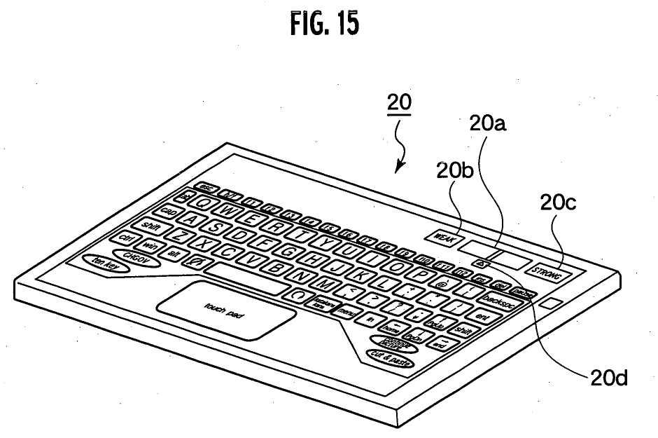

The thresholds used to determine the contact state are adjustable. For instance, the device control IC23 indicates a key 20b (WEAK), a key 20c (STRONG), and a level meter 20a, which shows levels of the thresholds. Refer to FIG. 15. It is assumed here that the level meter 20a has set certain thresholds for the states “contact” and “key hitting” beforehand. If the user gently hits an image, such key-hitting is often not recognized. In such a case, the “WEAK” button 20b is pressed. The device control IC 23 determines whether or not the “weak” button 20b is pressed, on the basis of the position of the button 20b on the display panel 5, and the contact position detected by the contact detecting unit 21. When the button 20b is recognized to be pressed, the display driver 22 is actuated in order to move a value indicated on the level meter 20a to the left, thereby lowering the threshold. In this state, the image is not actually pushed down, but pressure is simply applied onto the image. For the sake of simplicity, the term “key hitting” denotes that the user intentionally pushes down the image. Alternatively, the indication on the level meter 20a may be changed by dragging a slider 20d near the level meter 20a.

The device control IC 23 (as a notifying section) informs the motherboard 30a (shown in FIG. 5) of the operated keyboard or mouse as the input device and the contact state received from the contact detecting unit 21. In short, the position of the key pressed in order to input information, or the position of the key on which the object is simply placed is informed to the motherboard 30a.

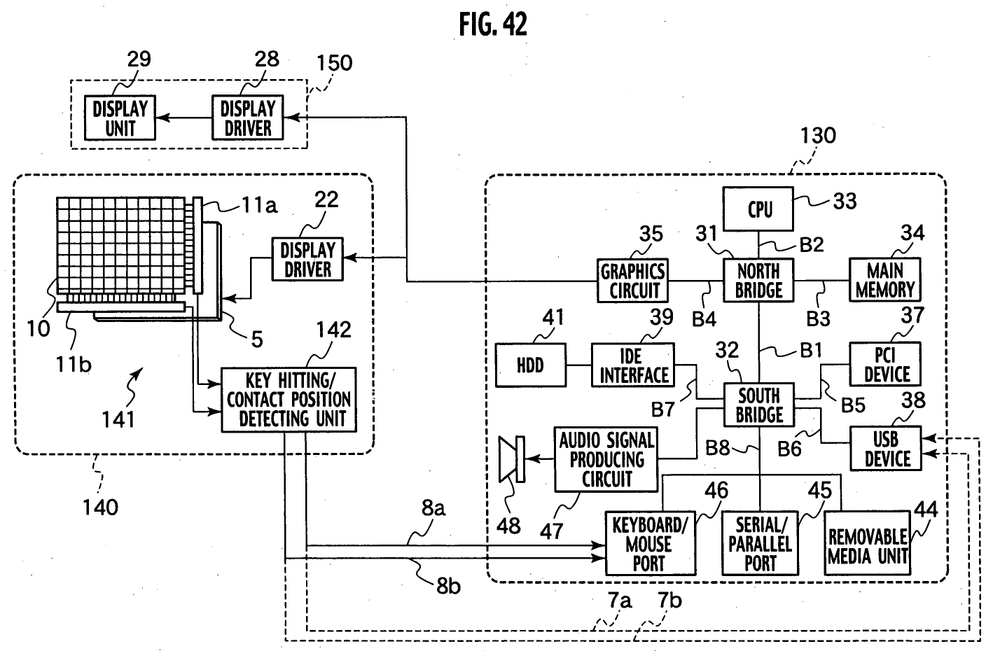

The device control IC 23 (as an arithmetic unit) derives a value for correcting the position, size or shape of the input device shown on the display unit on the basis of vector data representing a difference between the contact position and the center of an image indicating the input device. Further, the device control IC 23 derives an amount for correcting the position, size or shape of the input device shown on the display unit on the basis of the user information. Here, the user information is used to identify the user, e.g. a size of a user's palm which can be used to identify the user. The user information is stored in a memory unit 24 (shown in FIG. 4). When the input device is external unit, the user information is stored in a memory unit of the computer to which the input device is connected (as shown in FIG. 42 to FIG. 44 to be described later).

It is assumed that the keyboard is indicated as the input device. When a character string S containing N characters is entered on the keyboard, the device control IC 23 (the arithmetic unit) calculates a two-dimensional coordinate conversion T which is used to minimize a total difference between U sets of coordinates of a predetermined character string S containing N characters and entered by a user and C′ sets of the center coordinates of the character string S which are obtained by applying the two-dimensional coordinate conversion T to C sets of the center coordinates of the character string S put using a current keyboard layout. The arithmetic unit determines a new keyboard layout on the basis of the C′ sets of the center coordinates.

On the basis of key information, the device control IC 23 further modifies the keyboard layout, and performs fine adjustment of positions, shapes and angles of the keys. Fine adjustment intervals will be set to a certain value. When the object comes into contact with a certain key, the device control IC 23 indicates the image representing the input device which was used for previous data inputting and of which data were stored in the memory 24.

The device control IC 23 (as a summing unit) adds up an on-the-center key hit ratio or a target key hit ratio when the keyboard is indicated as the input device. The on-the-center key hit ratio denotes a ratio at which the center of the key is hit while the target key hit ratio denotes a ratio at which desired keys are hit.

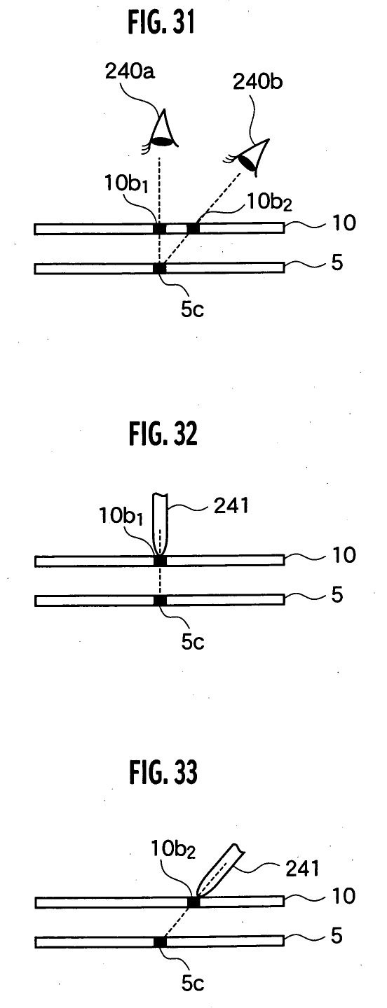

When the object is touched on the contact detecting surface 10a of the touch panel 10 vertically or slantingly (as shown in FIG. 31), the device control IC 23 (as a correcting unit) adjusts a position of the input device indicated on the display panel. Further, the device control IC 23 adjusts the position of the input device using a difference between the contact position and a reference position of an input image when the object is contacted slantingly.

The device control IC 23 (as a display controller) shown in FIG. 4 changes the indication mode of the image on the display unit 5 in accordance with the contact state (“non-contact”, “contact” or “key hitting”) of the object on the contact detecting layer 10a. Specifically, the device control IC 23 changes brightness, colors profiles, patterns and thickness of profile lines, blinking/steady lighting, blinking intervals of images in accordance with the contact state.

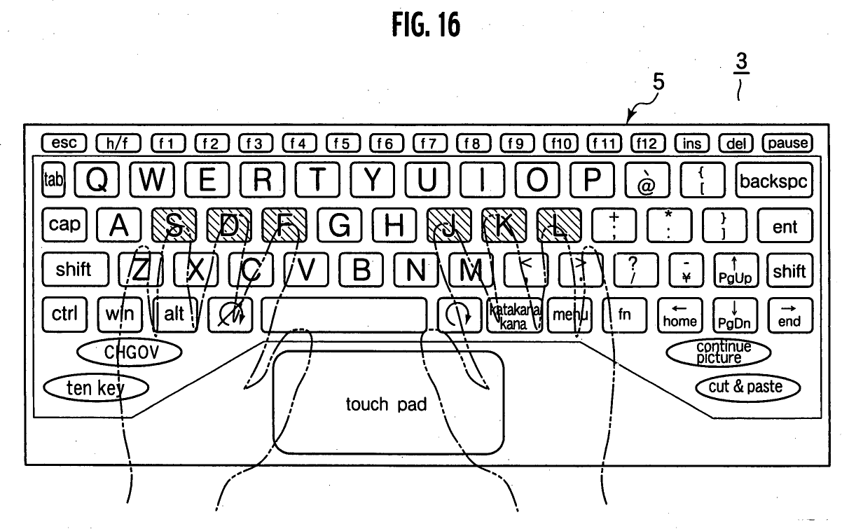

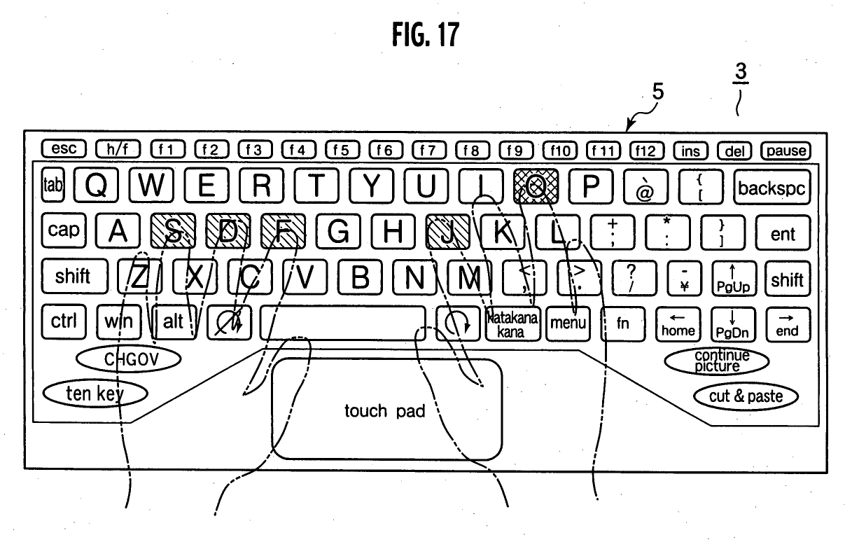

It is assumed here that the display unit 5 indicates the virtual keyboard, and the user is going to input information. Refer to FIG. 16. The user places his or her fingers at the home positions in order to start to key hitting. In this state, the user's fingers are on the keys “S”, “D”, “F”, “J”, “K” and “L”. The device control IC 23 lights the foregoing keys in yellow, for example. The device control IC lights the remaining non-contact keys in blue, for example. In FIG. 17, when the user hits the key “O”, the device control IC 23 lights the key “O” in red, for example. The keys “S”, “D”, “F” and “J” remain yellow, which means that the user's fingers are on these keys.

If it is not always necessary to identify “non-contact”, “contact” and “key hitting”, the user may select the contact state in order to change the indication mode.

Further, the device control IC 23 indicates a contour of the object on the display unit 5. For instance, the contour of the user's palm (shown by solid-dash-dash line in FIG. 16) may be indicated on the display unit 5. Further, the device control IC 23 indicates the mouse as the input device along the contour of the user's palm.

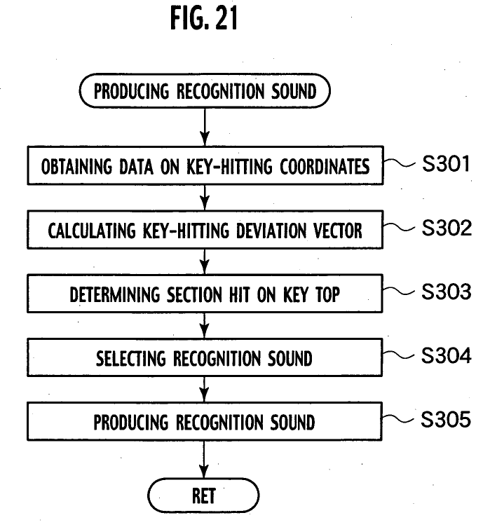

Further, the device control IC 23 functions as a sound producing section, decides a predetermined recognition sound in accordance with the contact state on the basis of the relationship between the position detected by the contact detecting section 21 and the position of the image of the virtual keyboard or mouse, controls the speaker driver 25, and issues the recognition sound via the speaker 26. For instance, it is assumed that the virtual keyboard is indicated on the display unit 5, and that the user may hit a key. In this state, the device control IC 23 calculates a relative position of the key detected by the contact detecting unit 21 and the center of the key indicated on the display unit 5. This calculation will be described in detail later with reference to FIG. 21 to FIG. 23.

When key hitting is conducted and a relative distance between an indicated position of a hit key and the center thereof is found to be larger than a predetermined value, the device control IC 23 actuates the speaker driver 25, thereby producing a notifying sound. The notifying sound may have a tone, time interval, pattern or the like different from the recognition sound issued for the ordinary “key hitting”.

It is assumed here that the user enters information using the virtual keyboard on the display unit 5. The user puts the home position on record beforehand. If the user places his or her fingers on keys other than the home position keys, the device control IC 23 recognizes that the keys other than the home position keys are in contact with the user's fingers, and may issue another notifying sound different from that issued when the user touches the home position keys (e.g. a tone, time interval or pattern).

A light emitting unit 27 is disposed on the input device, and emits light in accordance with the contact state determined by the device control IC 23. For instance, when it is recognized that the user places his or her fingers on the home position keys, the device control IC 23 makes the light emitting unit 27 luminiferous.

The memory 24 (shown in FIG. 4) stores data on the contact position and contact strength of the object, and vector data representing a difference between the contact position and the center of the image showing the input device.

Further, the memory 24 stores vector data representing a difference between the position detected by the contact detector 21 and the center of keys on the keyboard. The memory 24 also stores data on the number of times the delete key is hit, and data concerning a kind of keys hit immediately after the delete key.

Still further, the memory 24 stores the image of the input device on which the object is touched and the user information recognized by the touch panel 10, both of which are made to correspond each other.

The memory 24 stores histories of contact positions and contact strength of the object for a predetermined time period. The memory 24 may be a random access memory (RAM), a nonvolatile memory such as a flash memory, a magnetic disc such as a hard disc or a flexible disc, an optical disc such as a compact disc, an IC chip, a cassette tape, and so on.

The input device 20 of this embodiment includes a display unit which indicates an interface state (contacting, key hitting, a position of hands, automatic adjustment, a user's name, and so on) by using at least figure, letter, symbol, or lighting indicator. This display unit may be the display unit 5 or may be a separate member.

The following describe how to store various information processing programs. The input device 20 stores in the memory 24 information processing programs, which enable the contact position detecting unit 21 and device control IC 23 to detect contact positions and contact strength, to determine contact states, to perform automatic adjustment, to enable typing practice, to perform retyping adjustment, to indicate the operation of the mouse, to perform eyesight calibration, and so on. The input device 20 includes an information reader (not shown) in order to store the foregoing programs in the memory 24. The information reader obtains information from a magnetic disc such as a flexible disc, an optical disc, an IC chip, or a recording medium such as a cassette tape, or downloads programs from a network. When the recording medium is used, the programs may be stored, carried or sold with ease.

The input information is processed by the device control IC 23 and so on which execute the programs stored in the memory 24. Refer to FIG. 18 to FIG. 23. Information processing steps are executed according to the information processing programs.

It is assumed that the user inputs information using the virtual keyboard shown on the display unit 5 of the input unit 3.

The information is processed in the steps shown in FIG. 18. In step S101, the input device 20 shows the image of an input device (i.e., the virtual keyboard) on the display unit 5. In step S102, the input device 20 receives data of the detection areas on the contact detecting layer 10a of the touch panel 10, and determines whether or not there is a detection area in contact with an object such as a user's finger. When there is no area in contact with the object, the input device 20 returns to step S102. Otherwise, the input device 20 advances to step S104.

The input device 20 detects the position where the object is in contact with the contact detecting layer 10a in step S104, and detects contact strength in step S105.

In step S106, the input device 20 extracts a feature quantity corresponding to the detected contact strength, compares the extracted feature quantity or a value calculated using the feature quantity with a predetermined threshold, and identifies a contact state of the object on the virtual keyboard. The contact state is classified into “non-contact”, “contact” or “key hitting” as described above. FIG. 7 shows the “key hitting”, i.e., the contact area A is substantially zero at first, but abruptly increases. This state is recognized as the “key hitting”. Specifically, a size of the contact area is extracted as the feature quantity as shown in FIG. 6 and FIG. 7. An area velocity or an area acceleration is derived using the size of the contact area, i.e., a feature quantity ΔA/Δt or Δ²A/Δt² is calculated. When this feature quantity is above the threshold, the contact state is determined to be the “key hitting”.

The threshold for the feature quantity ΔA/Δt or Δ²A/Δt² depends upon a user or an application program in use, or may gradually vary with time even if the same user repeatedly operates the input unit. Instead of using a predetermined and fixed threshold, the threshold will be learned and re-calibrated at proper timings in order to improve accurate recognition of the contact state.

In step S107, the input device 20 determines whether or not the key hitting is conducted. If not, the input device 20 returns to step S102, and obtains the data of the detection area. In the case of the “key hitting”, the input device 20 advances to step S108, and notifies the computer main unit 30 of the “key hitting”. In this state, the input device 20 also returns to step S102 and obtains the data of the detection area for the succeeding contact state detection. The foregoing processes are executed in parallel.

In step S109, the input device 20 changes the indication mode on the virtual keyboard in order to indicate the “key hitting”, e.g., changes the brightness, color, shape, pattern or thickness of the profile line of the hit key, or blinking/steady lighting of the key, or blinking/steady lighting interval. Further, the input device 20 checks lapse of a predetermined time period. If not, the input device 20 maintains the current indication mode. Otherwise, the input device 20 returns the indication mode of the virtual keyboard to the normal state. Alternatively, the input device 20 may judge whether or not the hit key blinks the predetermined number of times.

In step S110, the input device 20 issues a recognition sound (i.e., an alarm). This will be described later in detail with reference to FIG. 21.

FIG. 19 shows the process of the “key hitting” in step S106.

First of all, in step S1061, the input device 20 extracts multiple variable quantities (feature quantities). For instance, the following are extracted on the basis of the graph shown in FIG. 7: a maximum size Aₘₐₓ of the contact area, a transient size S_{A} of the contact area A derived by integrating a contact area A, a time T_{P} until the maximum size of the contact area, and a total period of time Tₑ of the key hitting from the beginning to end. A rising gradient k=Aₘₐₓ/T_{P} and so on are calculated on the basis of the foregoing feature quantities.

The foregoing qualitative and physical characteristics of the feature quantities show the following tendencies. The thicker the user's fingers and stronger the key hitting, the larger the maximum size Aₘₐₓ of the contact area. The stronger the key hitting, the larger the transient size S_{A} of the contact area A. The more soft the user's fingers and the stronger and slower the key hitting, the longer the time until the maximum size of the contact area T_{P}. The slower the key hitting and the more soft the user's fingers, the longer the total period of time Tₑ. Further, the quicker and stronger the key hitting and the harder the user's fingers, the larger the rising gradient k=Aₘₐₓ/T_{P}.

The feature quantities are derived by averaging values of a plurality of key-hitting times of respective users, and are used for recognizing the key hitting. Data on only the identified key hitting are accumulated, and analyzed. Thereafter, thresholds are set in order to identifying the key hitting. In this case, the key hitting canceled by the user are counted out.

The feature quantities may be measured for all of the keys. Sometimes, the accuracy of recognizing the key hitting may be improved by measuring the feature quantities for every finger, every key, or every group of keys.

Separate thresholds may be determined for the foregoing variable quantities. The key hitting may be identified on the basis of a conditional branch, e.g., when one or more variable quantities exceed the predetermined thresholds. Alternatively, the key hitting may be recognized using a more sophisticated technique such as the multivariate analysis technique.

For example, a plurality of key-hitting times are recorded. Mahalanobis spaces are learned on the basis of specified sets of multivariate data. A Mahalanobis distance of the key hitting is calculated using the Mahalanobis spaces. The shorter the Mahalanobis distance, the more accurately the key hitting is identified. Refer to “The Mahalanobis-Taguchi System, ISBN0-07-136263-0, McGraw-Hill, and so on.

Specifically, in step S1062 shown in FIG. 19, an average and a standard deviation are calculated for each variable quantity in multivariate data. Original data are subject to z-transformation using the average and standard deviation (this process is called “standardization”). Then, correlation coefficients between the variable quantities are calculated to derive a correlation matrix. Sometimes, this learning process is executed only once when initial key hitting data are collected, and is not updated. However, if a user's key hitting habit is changed, if the input device is mechanically or electrically aged, or if the recognition accuracy of the key hitting lowers for some reason, relearning will be executed in order to improve the recognition accuracy. When a plurality of users login, the recognition accuracy may be improved for each user.

In step S1063, the Mahalanobis distance of key hitting data to be recognized is calculated using the average, standard deviation and a set of the correlation matrix.

The multivariate data (feature quantities) are recognized in step S1064. For instance, when the Mahalanobis distance is smaller than the predetermined threshold, the object is recognized to be in “the key hitting” state.

When the algorithm in which the shorter the Mahalanobis distance, the more reliably the key hitting may be recognized is utilized, the user identification can be further improved compared with the case where the feature quantities are used as they are for the user identification. This is because when the Mahalanobis distance is utilized, the recognition, i.e., pattern recognition, is conducted taking the correlation between the learned variable quantities into consideration. Even if the peak value Aₘₐₓ is substantially approximate to the average of the key hitting data but the time T_{P} until the maximum size of the contact area is long, a contact state other than the key hitting will be accurately recognized.

In this embodiment, the key hitting is recognized on the basis of the algorithm in which the Mahalanobis space is utilized. It is needless to say that a number of variable quantities may be recognized using other multivariate analysis algorithms.

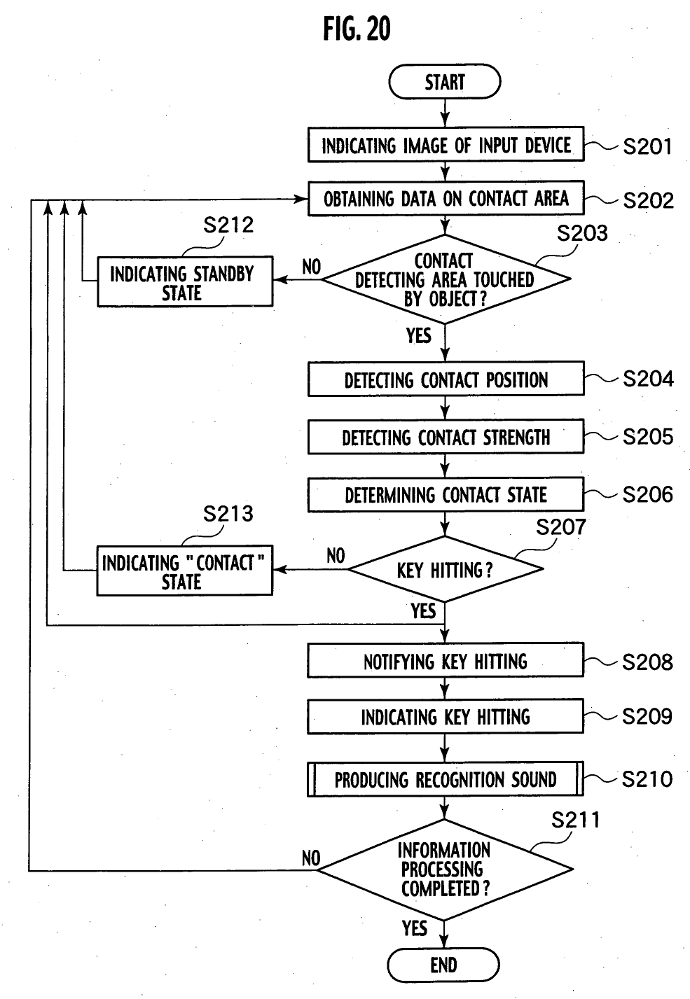

The following describe a process to change indication modes for indicating the “non-contact” and “contact” states' with reference to FIG. 20.

Steps S201 and S202 are the same as steps S101 and S102 shown in FIG. 18, and will not be referred to.

In step 203, the input device 20 determines whether or not the contact detecting layer 10a is touched by the object. If not, the input device 20 advances to step S212. Otherwise, the input device 20 goes to step S204. In step S212, the input device 20 recognizes that the keys are in the “non-contact” state on the virtual keyboard, and changes the key indication mode (to indicate a “standby state”). Specifically, the non-contact state is indicated by changing the brightness, color, shape, pattern or thickness of a profile line which is different from those of the “contact” or “key hitting” state. The input device 20 returns to step S202, and obtains data on the detection area.

Steps S204 to S206 are the same as steps S104 to S106, and will not be described here.

The input device 20 advances to step S213 when no key hitting is recognized in step S207. In step S213, the input device 20 recognizes that the object is in contact with a key on the virtual keyboard, and changes the indication mode to an indication mode for the “contact” state. The input device 20 returns to step S202, and obtains data on the detected area. When the key hitting is recognized, the input device 20 advances to step S208, and then returns to step S202 in order to recognize a succeeding state, and receives data on a detection area.

Steps S208 to S211 are the same as steps S108 to S111, and will not be described here.

In step S110 (shown in FIG. 18), the alarm is produced if the position of the actually hit key differs from an image indicated on the input device (i.e., the virtual keyboard).

Refer to FIG. 21, in step S301, the input device 20 acquires key hitting standard coordinate (e.g., barycenter coordinate which is approximated based on a coordinate group of the contact detector 10b of the hit key).

Next, in step S302, the input device 20 compares the key hitting standard coordinate and the standard coordinate (e.g., a central coordinate) of the key hit on the virtual keyboard. The following is calculated; a deviation between the key hitting standard coordinate and the standard coordinate (called the “key-hitting deviation vector”), i.e., the direction and length on x and y planes extending between the key hitting standard coordinate and the standard coordinate of the hit key.

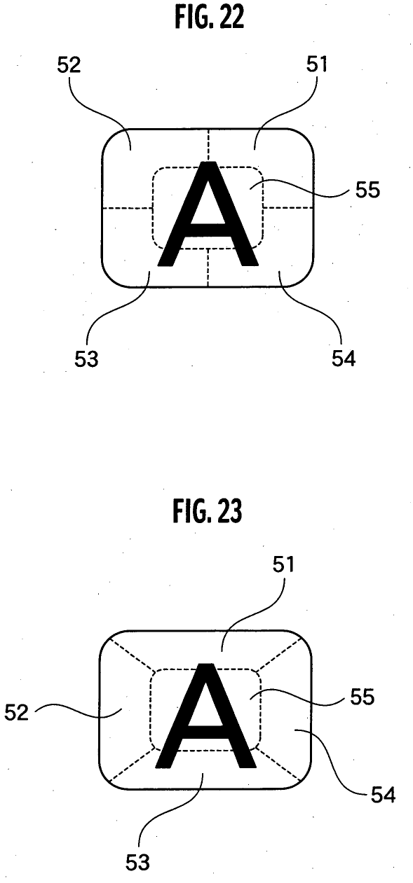

In step S303, the input device 20 identifies at which section the coordinate of the hit key is present on each key top on the virtual keyboard. The key top may be divided into two, or into five sections as shown in FIG. 22 and FIG. 23. The user may determine the sections on the key top. The sections 55 shown in FIG. 22 and FIG. 23 are where the key is hit accurately.

The input device 20 determines a recognition sound on the basis of the recognized section. Recognition sounds having different tones, time intervals or patterns are used for the sections 51 to 55 shown in FIG. 22 and FIG. 23.

Alternatively, the input device 20 may change the recognition sounds on the basis of the length of the key-hitting deviation vector. For instance, the longer the key hitting deviation vector, the higher pitch the recognition sound has. The intervals or tones may be changed in accordance with the direction of the key hitting deviation vector.

If the user touches across two sections of one key top, an intermediate sound may be produced in order to represent two sections. Alternatively, the inner sound may be produced depending upon respective sizes of contacted sections. A sound may be produced for a larger section, or two sounds may be issued as a chord.

In step S305, the input device 20 produces the selected recognition sound at a predetermined volume. The input device 20 checks the elapse of a predetermined time period. If not, the recognition sound will be continuously produced. Otherwise, the input device 20 stops the recognition sound.

With respect to step S304, the different recognition sounds are provided for the sections 51 to 55. Alternatively, the recognition sound for the section 55 may be different from the recognition sounds for the sections 51 to 54. For instance, when the section 55 is hit, the input device 20 recognizes the proper key hitting, and produces the recognition sound which is different from the recognition sounds for the other sections. Alternatively, no sound will be produced in this case.

The user may determine a size or shape of the section 55 as desired depending upon its percentage or a ratio on a key top. Further, the section 55 may be automatically determined based on a hit ratio, or a distribution of x and y components of the key hitting deviation vector.

Alternatively, a different recognition sound may be produced for the sections 51 to 54 depending upon whether the hit part is in or out of the section 55.

The sections 55 of all of the keys may be independently or simultaneously adjusted, or the keys may be divided into a plurality of groups, each of which will be adjusted individually. For instance, key hitting deviation vectors of the main keys may be accumulated in a lump. Shapes and sizes of such keys may be simultaneously changed.

Automatic Adjustment Process:

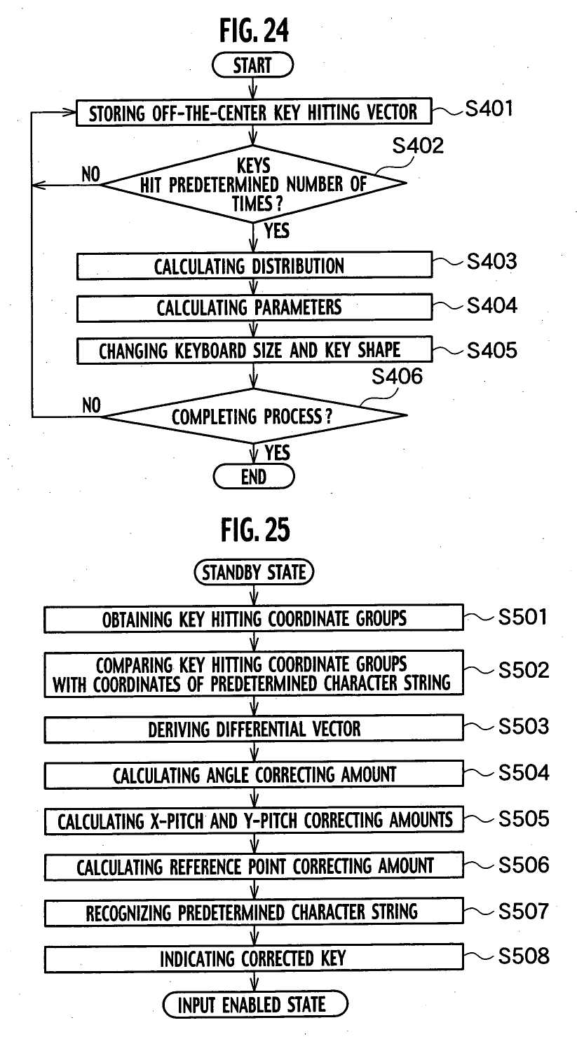

An automatic adjustment process will be described hereinafter. In this process, the position, size and shape of the keys are adjusted on the basis of a difference between the keys indicated on the keyboard and the input position with reference to FIG. 24. This adjustment process may be carried out for each key step by step, for all of the keys collectively, or separately for groups of keys. For instance, the process may be designed in such a manner that key-hitting deviation vectors may be accumulated for a group of main keys, and parameters for changing shapes or sizes of the main keys may be changed at the same time.

The key-hitting deviation vector in step S401 is the same manner as that in step S302 shown in FIG. 21, and will not be described here. The input device 20 stores the key-hitting deviation vector data in the memory 5.

In step S402, the input device 20 checks whether or not each key or each group of keys is hit on the keyboard at the predetermined timings. Key hitting intervals may be accumulated. An adjustment parameter, which is derived on the basis of data of n-time key hitting in the past, may be used for each key hitting (“n” is a natural number). If “n” is set to an appropriate number, the foregoing algorithm can optimize the layout, shape or size of the keyboard each time a key is hit. Further, it is possible to avoid a problem of hard-to-use the input device or a sense of discomfort because of rapid change of the layout, shape or size.

The input device 20 assumes a distribution of key-hitting deviation amount, and calculates an optimum distribution in step S403. Then, the input device 20 calculates one or more parameters for defining a shape of distribution on the basis of distribution variation data in step S404.

In step S405, the input device 20 changes the position, size and shape and so on of the keyboard (input range) to be indicated.

In step S406, the input device 20 determines whether or not to complete the adjustment process. If the adjustment process is not completed, the input device repeats steps S401 to S405.

The user may wish to know a current state of the adjustment process executed by the input device 20. The input device 20 may be designed to indicate “storing the key-hitting deviation”, “the automatic adjustment under way” or “out of automatic adjustment” on the input device or on the display unit, when the foregoing algorithm is provided.

The following describe how to determine a parameter for an optimum keyboard pattern for the user. In this case, the image of the keyboard is not indicated on the display unit. When a predetermined character string (i.e., the password) is entered, the user is recognized to have an intention of inputting data. The input device 20 calculates an assumed user's key pitch. Refer to FIG. 25.

In addition to the key pitch, the optimum keyboard layout may be designed for each user by optimizing layout parameters such as the arrangement of characters, an inclination of a base line of the character string, and a curvature of the base line. It is possible to optimize the keyboard layout for every user.

Further, depending upon how the user enters the password, the input device 20 can recognize which keyboard the user wishes to use, e.g., the keyboard having the characters in the order of the “QWERY” or “DVORAK” character arrangement.

In step S501 (shown in FIG. 25), the input device 20 obtains data on coordinates of the key hit by the user, and compares the obtained coordinates with predetermined coordinates of the character (step S502).

In step S503, a differential vector group representing a difference between the coordinates of the hit key and the predetermined coordinates of the character is derived. The differential vector group comprises vectors corresponding to the entered characters (constituting the password). A primary straight line is created using the method of least square on the basis of a start point group composed of only start points of respective differential vectors and only an end-point group composed of end-points of the respective differential vectors.
y=a₁x+b₁
y=a₂x+b₂

In step S504, a₁ and a₂ are compared. Hence, it is checked how much the user deviates from a reference point in the xy plane when hitting the key. Angular correction amounts are calculated. Otherwise, the characters in the password are divided into groups in which the characters may have the same y coordinate in one line. Hence, angles in the x direction are averaged. The averaged angle is utilized as the angular correction amount as it is when the password characters are in one line.

Next, in step S505, a keyboard standard position of the start point groups are compared with a keyboard standard position which is estimated on the basis of the end-point groups, thereby calculating an amount for correcting the x pitch and y pitch. A variety of methods are conceivable for this calculation. For instance, a median point of the coordinates of the start point groups and a median point of the coordinates of the end-point groups may be simply compared, thereby deriving a difference between the x direction and the y direction.

In step S506, a pace of expansion (kx) in the x direction and a pace of expansion (ky) in the y direction are separately adjusted in order to minimize an error between x coordinates and y coordinates of the start point group and end-point group. Further, an amount for correcting the standard original point may be derived explanatorily (using a numerical calculation method) in order to minimize a squared sum of the error, or arithmetically using the method of least square.

In step S507, the input device 20 authenticates the character string of the password, i.e. determines whether or not the entered password agrees with the password stored beforehand.

In step S508, the input device 20 indicates a corrected input range (i.e., the virtual keyboard 25) on the basis of the angle correction amount, x-pitch and y-pitch correction amounts, and standard original point correction amount which have been calculated in steps S504 to S506.

The calculations in steps S504, S505 and S506, respectively, are conducted in order to apply suitable transformation T to the current keyboard layout, so that a preferable keyboard layout will be offered to the user. The current keyboard layout may be the same that has been offered when shipping the microcomputer, or that was corrected in the past.

Alternatively, the transformation T may be derived as follows. First of all, the user is requested to hit a character string S composed of N characters. A set U of N two-dimensional coordinates (which deviate from the coordinates of the center of the key top) on the touch panel is compared to the coordinates C of the center of the key tops of the keys for the character string S. The transformation T will be determined in order to minimize a difference between the foregoing coordinates as will described hereinafter. Any method will be utilized for this calculation. The two-dimensional coordinates or two-dimensional vectors are denoted by “[x, y]”.

The set U composed of N two-dimensional coordinates is expressed as [xi, yi] (i=1, 2, . . . , N). A center coordinate C′ after the transformation T is expressed as [ξ i, η i] (i=1, 2, . . . , N). The transformation T is accomplished by parallel displacement, rotation, expansion or contraction of the coordinate group. [e, f] denotes a vector representing the parallel displacement. θ denotes a rotation angle. A denotes an magnification/contraction coefficient. [e, f]=[c−a, d−b] may be calculated on the basis of the center point [a, b] of the current keyboard layout as a whole, and an average coordinate of U [c, d]=[(x1+x2 . . . +xN)/N, (y1+y2 . . . +yN)/N]. When the current keyboard layout is transformed in accordance with the rotation angle θ and expansion/contraction coefficient λ, the transformed coordinates will be [ξi, ηi]=[λ{(Xi−e) cos θ−(Yi−f) sin θ}, λ{(Xi−e) sin θ+(Yi−f) cos θ}], (i=1, 2 . . . ; N). It is assumed there that initial entries of θ and λ are set to be 0 and 1, respectively. The parameters θ and λ (which minimize a sum α=Δ1+Δ2+ . . . , ΔN of a squared distance Δi=(ξi−xi)ˆ2+(ηi−yi)ˆ2) are numerically derived using a Sequential Quadratic Programming (SQP) method. The transformed coordinate set [ξi, ηi](i=1, 2, . . . , N) derived by applying the calculated θ and λ denotes a new keyboard layout. When the transformed coordinate set C′ has a large margin of error due to mistyping or the like, θ and λ may not become converged. In such a case, no authentication of the letter strings is carried out, and the keyboard layout should not be adjusted. Therefore, the user is again requested to hit the keys for the letter string S.

Alternatively, sometimes more preferable results may be accomplished when λ is adjusted respectively in the x and y directions, so that the traverse pitch and the vertical pitch can be optimized.

Further, when the transformation T is appropriately devised, the keyboard layout may be adjusted on a keyboard on which keys are arranged in a curved state, a keyboard on which a group of keys hit by the left hand and a group of keys hit by the right hand are arranged at separated places.

The foregoing layout adjustment may-be applied separately to the keys hit by the left and right hands. The forgoing algorithm may be applied in order to anomalistically arrange the left-hand and right-hand keys in a fan shape as in some computers on the market.

The foregoing correction is used only at the time of authentication. The corrected key layout will not be indicated on the display unit, or partially corrected or modified keyboard layout may be indicated only when the pitch adjustment is conducted. When the keys are arranged deviating from the edge of the lower housing, or when they are arranged asymmetrically, the use may feel uncomfortable with the keyboard. In such a case, the rotation angle will not be arranged or the keys will be arranged symmetrically.

The keyboard layout will be improved with respect to its convenience and appearance by applying a variety of geometrical restrictions as described above.

In the foregoing embodiment, the input device 20 stores the image of the input device based on the user's fingers, and the user's information detected on the contact detecting surface, both of which are made to correspond. When the object is contacted onto the image of the input device on the display unit, the input device 20 may derive a correction amount for the position, size or shape of the image of the input device on the display unit based on the user's information. For instance, the size of the user's hand detected on the detecting surface 10 may be converted into a parameter representing the hand size. Then, the size of the image of the input device may be changed in accordance with the foregoing parameter.

The size and layout of the keys are dynamically adjusted as in the process shown in FIG. 25. However, if the adjustment algorithm is too complicated or if there are too many adjustment parameters, the size and layout of the keys may become tricky to use, or non-adjustable parameters which make the image run off a displayable area. In the algorithm shown in FIG. 25, (1) an angle correcting amount, (2) x-pitch and y-pitch correcting amounts, and (3) reference point correcting amount are independently adjusted. Alternatively, a simple algorithm may be used after the algorithm shown in FIG. 19. In the simple algorithm, keyboard patterns determined by a single or a plurality of parameters may be stored beforehand. Only the x-pitch or y-pitch may be reflected with respect to lengthwise and crosswise sizes in the predetermined keyboard pattern.

With the foregoing conversion, the displacement of the reference position, e.g., parallel displacement, and the layout may not be adjusted with flexibility. However, the user can practically operate the input device without any problem and will not be embarrassed at a variety of different or complicated operations.

Type Practice Process:

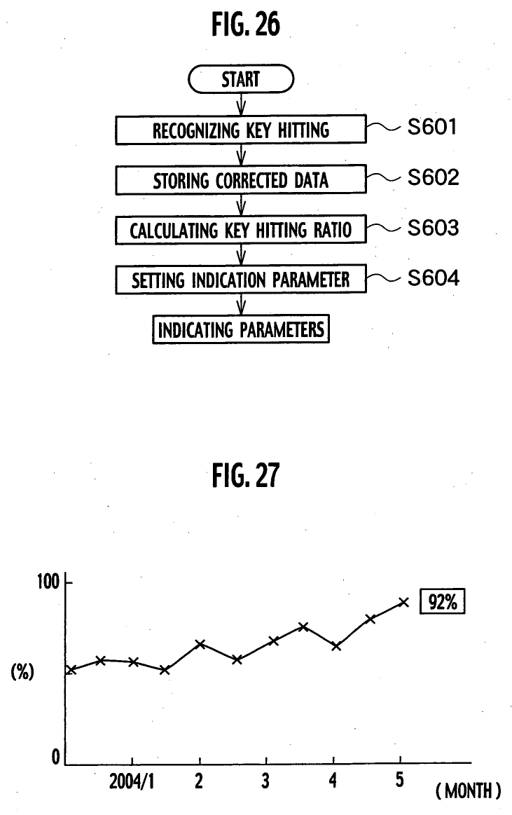

A typing practice process will be described with reference to FIG. 26 and FIG. 27. In this process, the input device 20 accumulates the following data for every user: the on-the center key hit ratio which denotes whether or not the user hits the center of each key or a hit ratio of target keys whether or not the user accurately hits his or her target keys. This process offers a program which enables the user to practice typing keys with low hit ratios.

In step S601 shown in FIG. 26, the input device 20 instructs the user to input a typing practice code, and recognizes that the user inputs the code on the virtual keyboard 25.

In step S602, the input device 20 stores the input position and a correction history in the memory 24.

The input device 20 calculates the on-the center key hit ratio or hit ratio of target keys in step S603.

In step S604, the input device 20 sets out a parameter in order to graphically show a time-dependent variation of the on-the center key hit ratio or hit ratio of target keys.

In step S605, the input device 20 indicates a graph as shown in FIG. 27.

Further, the input device 20 ranks scores of respective keys, and may ask the user to intensively practice hitting keys with low hit scores.

Adjustment for Retype Keys:

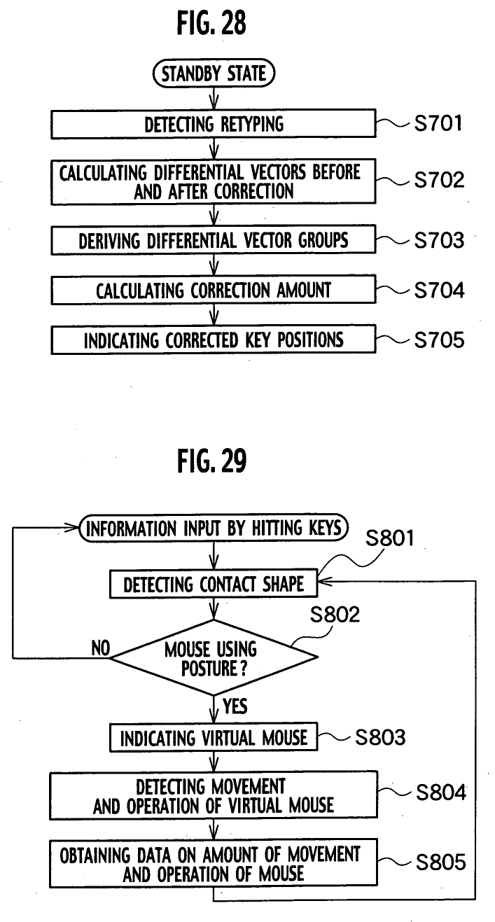

The input device 20 executes an adjustment process for retyped keys on the basis of information such as the number of times the delete key is hit, and kinds of keys retyped immediately after the delete key. In this process, the input device 20 changes the keyboard layout or performs fine adjustment of positions, shapes and angles of keys as shown in FIG. 28.

First of all, in step S701, the input device 20 detects that the user retypes a character on the virtual keyboard 5a. For instance, the input device 20 recognizes that the user hits the key “R” on the QWERTY keyboard, cancels the key “R” using the delete key, and retypes “E”.

In step S702, the input device 20 calculates differential vector data of the center of a finger which mistyped the key and the center of the retyped key.

Next, in step S703, the input device 20 derives groups of differential vector data on the number of times of the key in question mistyped in the past.

In step S704, the input device 20 averages the differential vector data groups, and calculates a correction amount by multiplying the averaged differential vector data group with a predetermined coefficient. If the coefficient is equal to or less than “1”, the correction amount is small. On the contrary, if the coefficient is approximately “1”, the correction amount is large. The smaller the coefficient, the smaller the correction amount. Further, the foregoing correction may be performed whenever the averaged number of times of the key recently mistyped is above the predetermined value, or may be periodically performed when the predetermined number of mistyping is counted.

In step S705, the input device 20 corrects the position of the mistyped key on the basis of the correction amount, and indicates the corrected key position on the display unit 5a.

Further, the input device 20 may determine one or more intervals for the fine adjustment of the keyboard layout.

Mouse Using Mode:

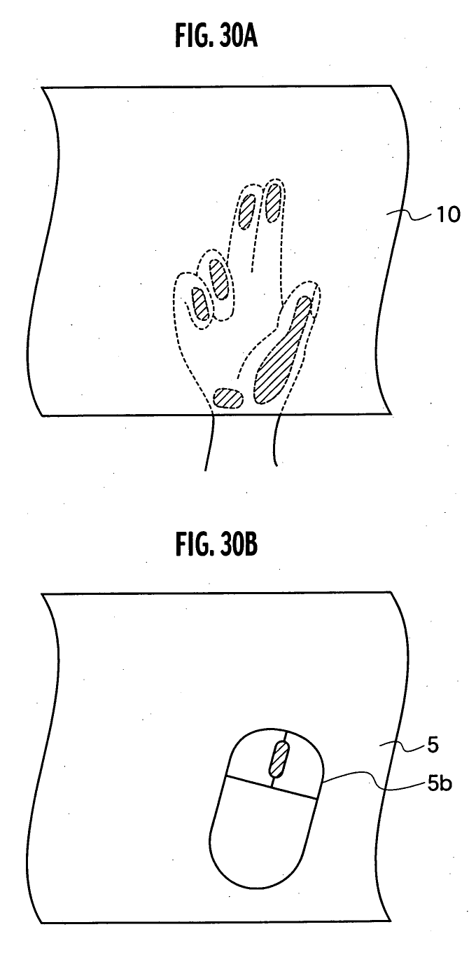

Referring to FIG. 29, FIG. 30A and FIG. 30B, the input device 20 indicates the virtual mouse 5b on the display unit 5a when the user's fingers are in a “mouse using” posture in order to input information.

In step S801, the input device 20 detects the, contact shape of the user's fingers on the touch panel 10.

In step S802, the input device 20 recognizes the mouse using posture, and advances to step S803. In other words, the user's fingers are in contact with the touch panel 10 as shown by shaded portions in FIG. 30A.

In step S803, the input device 20 sets down a reference position and a reference angle of the virtual mouse 5b, and indicates the virtual mouse 5b on the display unit 5 as shown in FIG. 30B. The reference position is determined under the user's fingers. In this state, the virtual mouse 5b may overlap on the keyboard, or may be indicated with the keyboard erased.

In step S804, the input device 20 detects clicking, wheel scrolling and so on performed by the user via the virtual mouse 5b. In step S805, the input device 20 obtains data on the amount of movement and operations performed using the virtual mouse 5b.

The procedures in steps S801 to S805 are repeated at a high speed, i.e., the contact shape and the mouse using posture are detected on real time. When the user stops using the virtual mouse 5b and removes his or her hand from the touch panel 10, and resumes hitting keys, the keyboard will be indicated immediately or after a predetermined delay.

Eyesight Calibration Process:

The following describe an eyesight calibration process which overcomes a problem caused by the user's viewing angle. Refer to FIG. 31. It is assumed that the user looks at an image on a pixel 5c on the display unit 5 and is going to touch the pixel 5c. If the user looks down the pixel 5c vertically (using the eyes 240a), the user touches the contact detector 10b₁. Conversely, when the user looks at the pixel 5c at a slant (using the eyes 240b), the user touches the contact detector 10b₂. If the user operates an object like a pen in order to touch the pixel 5c vertically, the object actually comes into contact with the contact detector 10b₁ as shown in FIG. 32. However, when viewed aslant, the object actually comes into contact with the contact detector 10b₂ as shown in FIG. 33.

The input device 20 accurately calculates the eyesight calibration amount by performing the vertical calibration and the oblique calibration in the actual use.

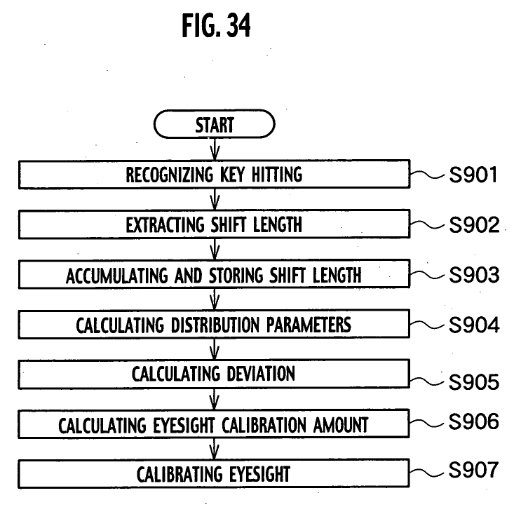

The eyesight calibration process will be described with reference to FIG. 34. In step S901, the input device 20 recognizes that the user hits keys on the virtual keyboard 5a.

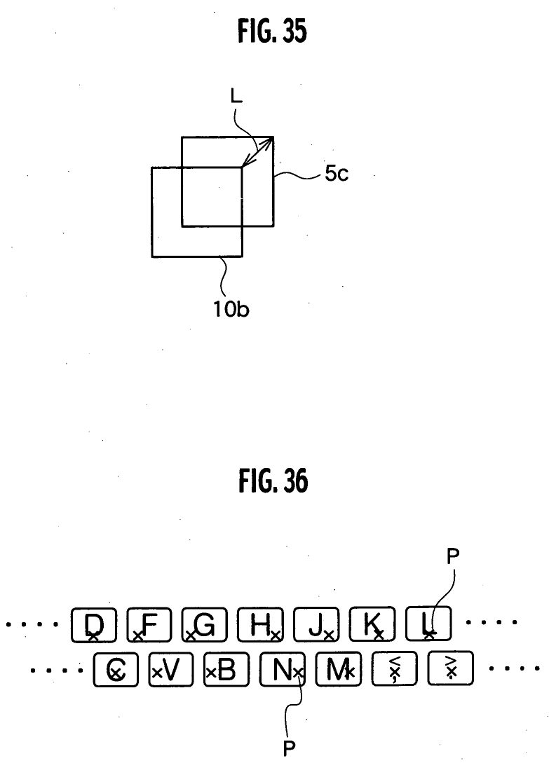

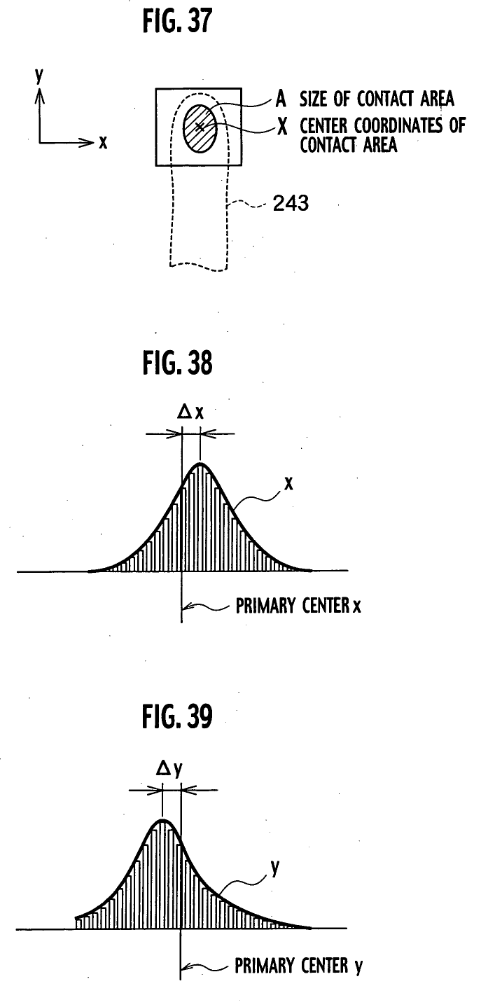

In step S902, the input device 20 extracts a shift length L to be Calibrated as shown in FIG. 35. The shift length L is a difference between the contact detector 10b on the touch panel 10 and the pixel 5c on the display unit 5. The larger the shift length L, the more extensively the hit position P of the key is displaced from the center of the key as shown in FIG. 36.

Next, in step S903, the input device 20 stores an accumulated shift length L. Specifically, the input device 20 calculates variations of contact coordinates of each key and the reference coordinates of the contact area, and stores them for each key.

In step S904, the input device 20 assumes a distribution of the shift length L, and calculates an optimum distribution of the shift length L. Specifically, the input device 20 calculates variations of the contact area of the finger in the x and y directions using a contact area A of a finger 243 and center coordinates X of the contact area A as shown in FIG. 38 and FIG. 39. Further, one or more parameters are calculated on the basis of the distribution of the shift length L.

In step S905, the input device 20 calculates deviation of the actual center coordinates of the key from the center of the distribution, i.e., Δx and Δy (FIG. 38, FIG. 39).

In step S906, the input device 20 calculates the eyesight calibration amount on the basis of the foregoing deviation. Specifically, the input device 20 adjusts any one of or all of the coordinates of the keys or keyboard to be indicated, and a geometry parameter, and calculates the eyesight calibration amount.

In step S907, the input device 20 indicates the keyboard after the eyesight calibration.

The eyesight calibration may be independently performed for each key, or simultaneously for all of the keys or for groups of keys. Accumulated intervals of the eyesight calibration of the respective keys or accumulated shift length L may be reset by repeating the foregoing algorithm whenever accumulation of each key hitting is performed the predetermined number of times. Alternatively, the number of times of key hitting may be accumulated each time the key is hit on the first-in and first-out basis, and the distribution of the off-the center hit amount may be adjusted each time the key is hit.

One or both of the display unit 5 and the touch panel 10 may undergo the eyesight calibration.

The following describe the difference between the automatic keyboard alignment on the basis of the shift length vector data, and the eyesight calibration.

When the shift length vector data are still observed even after the automatic keyboard alignment, they are often caused not by the user's inaccurate keying hitting but by a difference between viewing angles of the display unit 5 and the touch panel 10.

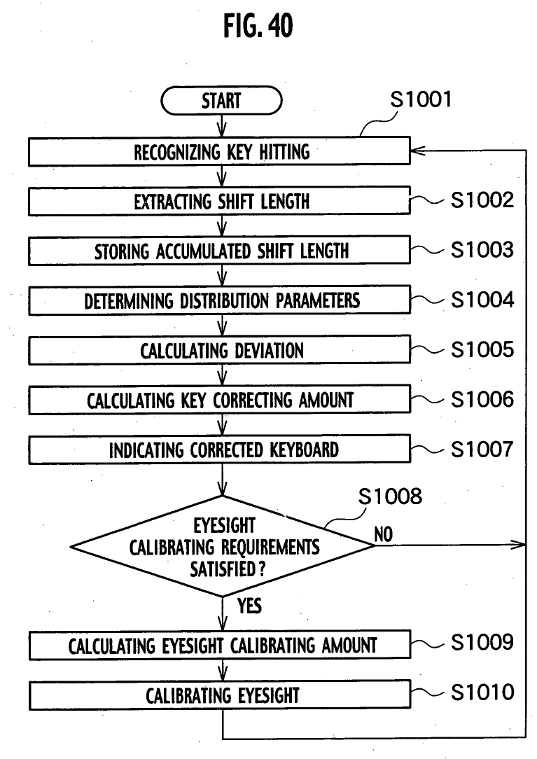

FIG. 40 shows an algorithm for determining whether or not the eyesight calibration should be conducted after the automatic keyboard alignment.

The procedures in steps S1001 to S1005 are the same as those in steps S901 to S905 shown in FIG. 34, and will not be described here.

In step S1006, the input device 20 calculates an amount to correct the keyboard image by the automatic keyboard alignment. In step S1007, the input device 20 corrects the keyboard image, and indicates the corrected image in step S1007.

In step S1008, the input device 20 checks whether or not the eyesight calibration requirements are satisfied. The eyesight calibration requirements denote a variety of conditions, i.e., the keyboard alignment is conducted the predetermined number of times, or a part or an entire area of the keyboard image is repeatedly corrected in a particular direction. The input information possessor 20 advances to step S1009 when the foregoing requirements are satisfied.

Procedures in steps S1009 and S1010 are the same as those of steps S906 and S907 shown in FIG. 34, and will not be described here.

Other Processing:

The input device 20 performs the following in addition to the foregoing processes. When the contact detecting unit 21 is constituted by a touch panel 210 as a pressure sensor (FIG. 8A˜FIG. 8C), the input device 20 calculates an average of the user's key-hitting pressure onto the contact detecting unit 21, and varies a threshold of the key touch in response to variations of the key hitting pressure with time.

The input device 20 calculates a latest predetermined time period or the average variation of the key hitting pressure of the predetermined number of time as a moving average, and determines a threshold for recognizing the key hitting. As the user operates the input device for a long period of time, the user's key-hitting behavior may vary. Even in such a case, the input device 20 can prevent the threshold from being lowered. Further, the information obtained through the observation on variations of the key-hitting pressure can be used to detect the user's fatigue or problems of the machine, for example.

Further, in order to perform the personal identification, the input device 20 stores dummy data of one or more users, and compares data of a new user with the dummy data with respect to specific features. It is assumed that only one new user is registered, and that a determination index is calculated on the basis of the Mahalanobis distance. In such a case, the determination index may be somewhat inaccurate because the Mahalanobis distance is calculated only on the basis of the new user's learned Mahalanobis space.

Fundamentally, the Mahalanobis distance is calculated on the basis of the Mahalanobis space of the specific user. The smaller the Mahalanobis distance, the more reliably the user may be identified. Sometimes, the Mahalanobis distance is increased when the key-hitting feature varies after the typing practice. In such a case, it is very difficult to recognize the user. Further, sometimes, it is difficult to determine the threshold for recognizing or not-recognizing the user.

On the contrary, the dummy data of one or more persons may be stored, and the Mahalanobis spaces of such users may be also stored. The Mahalanobis space of the user's input behavior to be recognized is calculated on the basis of a plurality of Mahalanobis spaces mentioned above. When the Mahalanobis distance calculated using the specific user's data is smaller than that calculated using the more than one users' data, the user in question can be more reliably identified.

The user identification can be reliably performed when a plurality of dummy data are stored rather than when data of only one user or a limited number of users is stored and the Mahalanobis space is learned for such limited users. Further, the user identification may be performed by determining a particular key or a particular finger beforehand. For instance, the key F (corresponding to the left forefinger) or the key J (corresponding to the right forefinger) may be used for this purpose. Still further, if the keyboard is gradually displaced as described above, it is possible to provide a function to return the keyboard to the original position set at the time of purchase, or to a position which is optimum to the user.

Through the use of the input device 20, the computer 1, the information processing method and program, the contact detecting unit 21 and the device control IC 23, it is possible to detect on the basis of the contact strength whether the user's finger is simply placed on the touch panel 10 or the user hits the touch panel 10 in order to input some data.

The contact strength can be detected on the basis of the size of the contact area or the contact pressure. According to this invention, the contact state can be accurately detected compared to the case in which only the key hitting pressure is relied upon in order to detect the contact state when the pressure sensor type touch panel of the related art is used.

Only the size and shape of the contact area are detected in the infrared ray type or image sensor type touch panel of the related art. Therefore, it is very difficult to recognize whether the object is simply placed on the key or the object is brought into contact with the key in order to input information. The input device 20 of the present invention can accurately and easily recognize the contact state of the object on the keyboard.

When the contact strength is detected on the basis of the contact pressure, the contact state of the object such as the input pen, which is relatively hard and thin, and whose contact area tends to remain the same, can be accurately detected by evaluating the rate of time-dependent pressure variations.

Up to now, it is very difficult to quickly recognize keys which are hit at the same time. The input device 20 can precisely recognize which finger hits the key and which fingers are simply placed on keys. Therefore, if a skilled user hits keys very quickly and sometimes hit keys in an overlapping manner, it is possible to recognize the contact state accurately.

The device control IC 23 compares the feature quantities related to the contact strength or a value calculated using the feature quantities with the predetermined threshold, and recognizes the contact state of the object. The threshold is adjusted depending upon the user's key hitting habits, which enables the same machine to be used by a plurality of users. The contact states can be accurately recognized for respective users. Further, if the key hitting strength varies as the user becomes familiar with the machine, an optimum use environment can be maintained if the user adjusts his or her key hitting. Still further, thresholds may be stored for respective login users, and may be used as defaults.

The display driver 22 and the display unit 5 can change modes of images of the input device in response to the contact state of keys. Refer to FIG. 4. For instance, when the keyboard is indicated as an input device, the user can easily know the “non-contact”, “contact” and “key hitting” states. This is very effective in helping the user become familiar with the machine. Indicating contacted keys in different modes is effective in letting the user know whether or not his or her fingers are on the home position

If the brightness of keys is changed depending upon their contact states, the user can use the input device 20 in a dim place. Further, colorful indications of the machine operation will offer the following effects: the user feels pleased and satisfied to use the machine, enjoys the sense of fan and feels happy to possess the machine, and so on.

The speaker driver 25 and the speaker 26 produce the predetermined recognition sounds depending upon the contact state on the basis of the relationship between the contact position of the object and the position of the image on the input device. The user can know the number of times of mistyping and the off-the center amount, so that the user can practice typing. This is effective in making the user familiar with the machine.

The device control IC 23 can notify the contact state to devices which operate in response to the output signal from the input device. For instance, recognizing that the user's fingers are placed on the home position, the device control IC 23 notifies this state to the terminal device connected thereto.

The light emitting device 27 emits light in accordance with the contact state. For instance, looking at the display panel, the user can know that his or her fingers are on the home position.

The automatic alignment of the input device 20 enables the size or shape of the keyboard on the basis of the off-the center vector data.

The typing practice function of the input device 20 enables the user to know which keys the user is not good at hitting, and to practice to hit those keys intensively at an early stage. The typing practice function of the invention is excellent in the following respect when compared with existing typing practice software. Not only the deviation between the center of the key and the center coordinates of the finger hitting the key but also the direction can be recognized as the vector data of the continuous quantity, so that the key hitting accuracy can be precisely diagnosed. It is possible to offer an adjustment guideline to the user, and to efficiency produce continuous character strings to be practiced.

The retyping adjustment of the input device 20 is effective in the following respects. It is assumed here that the user hit the key “R” first of all, and hits the delete key to cancel the key “R” after the input device 20 identifies the key “R”, and the user hits the key “E” which is left to the key “R”. In this state, the input device 20 stores the user's retyping history. If this kind of mistyping is often observed, keys adjacent to the key “E” may be moved to the right in order to reduce the mistyping.

The key position adjustment (fine adjustment) is executed at the predetermined interval, so that it is possible to prevent the input device 20 from performing the adjustment too frequently or to prevent the virtual keyboard 5a from being corrected too extensively. Otherwise, the virtual keyboard 5a may be moved extensively and be difficult to use.

When the image sensor or the touch pad detects that the user places his or her fist on the input device, the user is recognized to going to use the mouse in place of hitting keys. In this state, the reference position of the fist is determined to be the center of the right hand, and the reference angle is calculated on the basis of the positions of the palm and the folded fingers. The position and angle of the virtual mouse 5b are calculated on the basis of the foregoing data, and the virtual mouse 5b is indicated on the display unit. The virtual mouse 5b includes right and left buttons, and a scroll wheel, and functions similarly to a usual wheel mouse. The user can operate the microcomputer using the virtual mouse 5b.

Although the invention has been described with reference to a particular embodiment, it is to be understood that this embodiment is merely illustrative of the application of the principles of the invention and should not be construed in a limiting manner. Numerous other modifications may be made and other arrangements may be devised without departing from the spirit and scope of the present invention.

In the foregoing embodiment, the input unit 3 is integral with the computer 30. Alternatively, the input unit 3 may be separate from the computer 30, and be attached thereto using a universal serial bus or the like.

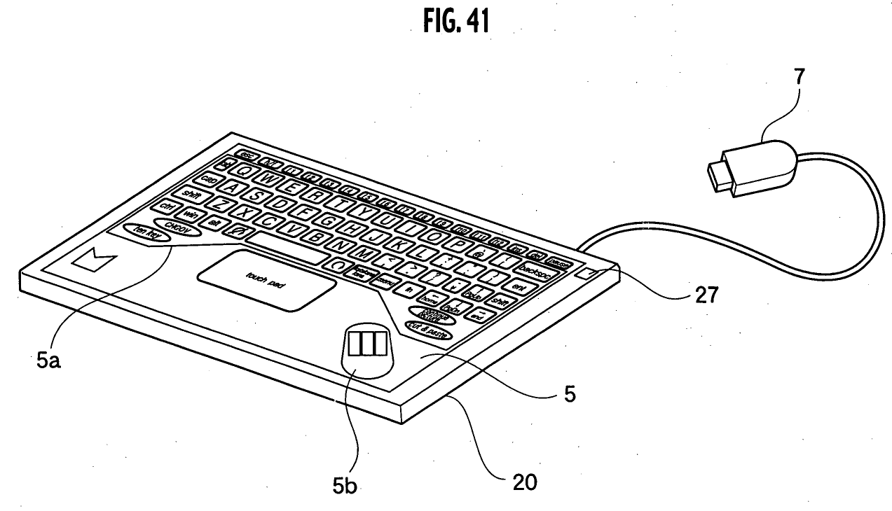

FIG. 41 shows an example in which an external input device 20 is connected to the microcomputer main unit, and images of the input device (e.g., a virtual keyboard 5a and a virtual mouse 5b) are shown on the display unit (LCD) 5. A USB cable 7 is used to connect the input device 20 to the microcomputer main unit. Information concerning keys hit on the keyboard is transmitted to the microcomputer main unit from the input device 20. The processed data are shown on the display unit connected to the computer main unit 130.

The input device 20 of FIG. 41 processes the information and shows the virtual keyboard 5a (as shown in FIG. 18 to FIG. 21) as the input device 3, virtual mouse 5b and so on the display unit 5, similarly to the input device 20 of FIG. 1. The operations may be executed under the control of the microcomputer main unit 130.

Referring to FIG. 42, a microcomputer main unit 130 is connected to an external input unit 140. The input device 141 receives digital image signals for the virtual keyboard and so on from a graphics circuit 35 (of the microcomputer main unit 130) via a display driver 22. The display driver 22 lets the display unit 5 show images of the virtual keyboard 5a and so on.

A key hitting/contact position detecting unit 142 detects a contact position and a contact state of the object on the contact detecting surface 10a of the touch panel 10, as described with reference to FIG. 18 to FIG. 21. The detected operation results of the virtual keyboard or mouse are transmitted to a keyboard/mouse port 46 of the computer main unit 130 via a keyboard connecting cable (PS/2 cables) or a mouse connecting cable (PS/2 cables).

The microcomputer main unit 130 processes the received operation results of the virtual keyboard or mouse, temporarily stores the operation results in a memory such as the hard disc drive 41, and executes the processes in accordance with the stored information. These processes are the basic information input process shown in FIG. 18 to FIG. 21; the automatic adjustment shown in FIG. 24 and FIG. 25; the typing practice processing shown in FIG. 26; the adjustment after retyping shown in FIG. 28; the mouse operation shown in FIG. 29; and the eyesight calibration shown in FIG. 31. The computer main unit 130 lets the graphics circuit 35 send a digital image signal representing the operation results to a display driver 28 of a display unit 150. The display unit 29 indicates images in response to the digital image signal. Further, the microcomputer main unit 130 sends the digital image signal to the display driver 22 from the graphics circuit 35. Hence, colors and so on of the indications on the display unit 5 (as shown in FIG. 16 and FIG. 17) will be changed.

In the foregoing case, the computer main unit 130 functions as the display controller, the contact strength detector, the arithmetic unit and the determining unit.

Alternatively the operation results of the virtual keyboard and mouse may be sent to the USB device 38 of the microcomputer main unit 130 via USB cables 7a and 7b in place of the keyboard connecting cable and mouse connecting cable, as shown by dash lines in FIG. 42.

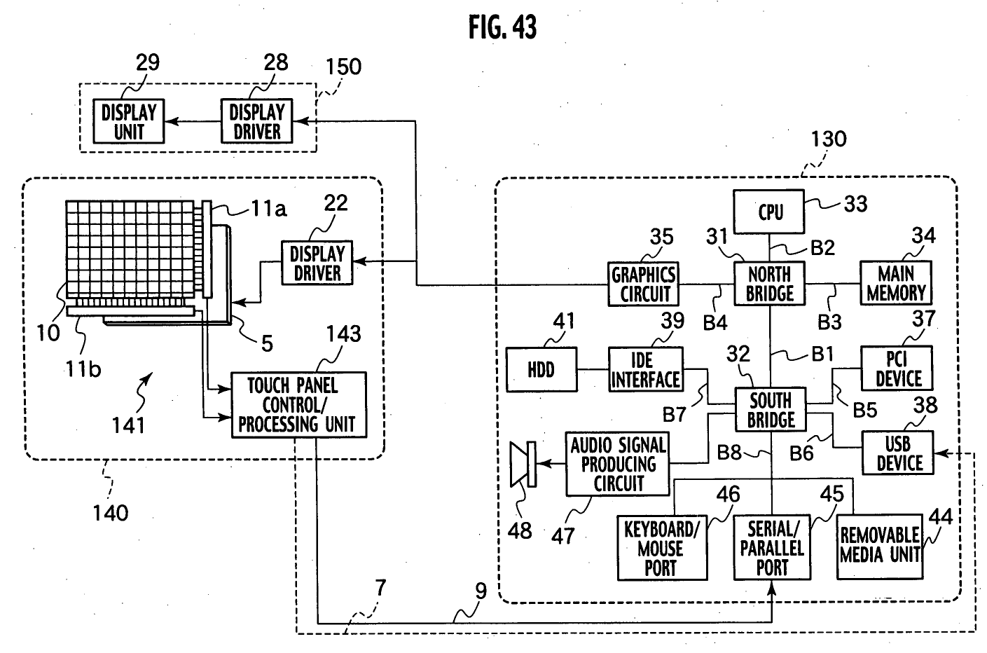

FIG. 43 shows a further example of the external input unit 140 for the microcomputer main unit 130. In the external input unit 140, a touch panel control/processing unit 143 detects keys hit on the touch panel 10, and sends the detected results to the serial/parallel port 45 of the microcomputer main unit 130 via a serial connection cable 9.

The microcomputer main unit 130 recognizes the touch panel as the input unit 140 using a touch panel driver, and executes necessary processes. In this case, the computer main unit 130 uses results of scanning at the touch panel which are received via the serial/parallel port 45, and are temporarily stored in the memory such as the hard disc drive 41. The processes are the basic information input process shown in FIG. 18 to FIG. 21; the automatic adjustment shown in FIG. 24 and FIG. 25; the typing practice processing shown in FIG. 26; the adjustment after retyping shown in FIG. 28; the mouse operation shown in FIG. 29; and the eyesight calibration shown in FIG. 31. Hence, the computer-main unit 130 assumes that the input device 141 is the touch panel, and performs necessary processes.

In the foregoing case, the computer main unit 130 functions as the display controller, the contact strength detector, the arithmetic unit and the determining unit.

In the example shown in FIG. 43, the operation state of the touch panel may be sent to the USB device 38 via the USB connecting cable 7 in place of the serial connection cable 9.

In the foregoing embodiment, the touch panel 10 is provided only in the input unit 3. Alternatively, an additional touch panel 10 may be provided in the display unit.

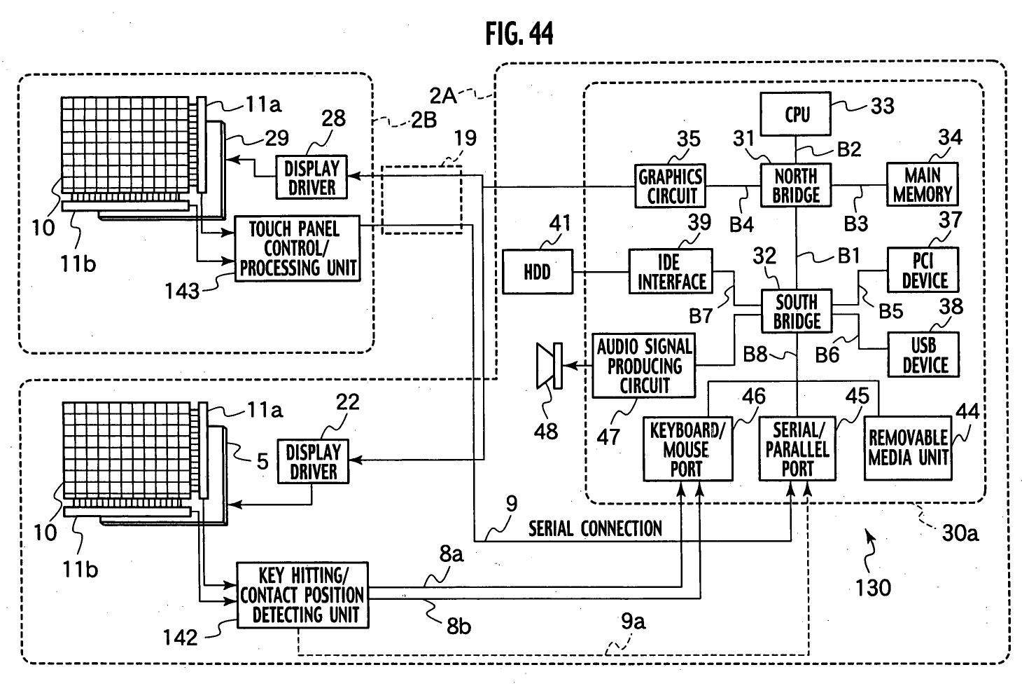

Referring to FIG. 44, the additional touch panel 10 may be installed in the upper housing 2B. Detected results of the touch panel 10 of the upper housing 2B are transmitted to the touch panel control/processing unit 143, which transfers the detected results to the serial/parallel port 45 via the serial connection cable 9.

The microcomputer main unit 130 recognizes the touch panel of the upper housing 2B using the touch panel driver, and performs necessary processing.

Further, the microcomputer main unit 130 sends a digital image signal to a display driver 28 of the upper housing 2B via the graphics circuit 35. Then, the display unit 29 of the upper housing 2B indicates various images. The upper housing 2B is connected to the microcomputer main unit 130 using a signal line via the hinge 19 shown in FIG. 1.

The lower housing 2A includes the key hitting/contact position detecting unit 142, which detects a contact position and a state of the object on the detecting layer 10b of the touch panel 10 as shown in FIG. 18 to FIG. 21, and provides a detected state of the keyboard or mouse to the keyboard/mouse port 46 via the keyboard connection cable or mouse connection cable (PS/2 cables).

The microcomputer main unit 130 provides the display driver 22 (of the input-unit 140) with a digital image signal on the basis of the operated state of the keyboard or mouse via the graphics circuit 35. The indication modes of the display unit 5 shown in FIG. 16 and FIG. 17 will be changed with respect to colors or the like.

In the foregoing case, the computer main unit 130 functions as the display controller, the contact strength detector, the arithmetic unit and the determining unit.

The operated results of the keyboard or mouse may be transmitted to the serial/parallel port 45 via the serial connection cable 9a in place of the keyboard or mouse connection cable, as shown by dash lines in FIG. 44.

In the lower housing 2A, the key hitting/contact position detecting unit 142 may be replaced with a touch panel control/processing unit 143 as shown in FIG. 44. The microcomputer main unit 130 may recognize the operated results of the keyboard or mouse using the touch panel driver, and perform necessary processing.

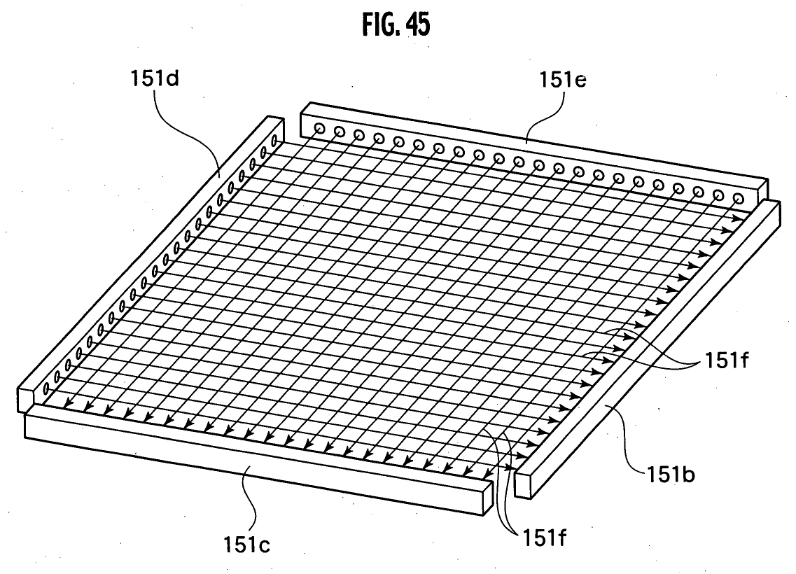

The resistance film type touch panel 10 is employed in the embodiment. Alternatively, an optical touch panel is usable as shown in FIG. 45. For instance, an infrared ray scanner type sensor array is available. In the infrared ray scanner type sensor array, light scans from a light emitting X-axis array 151e to a light receiving X-axis array 151c, and from a light emitting Y-axis array 151d to a light receiving Y-axis array 151b. A space where light paths intersect in the shape of a matrix is a contact detecting area in place of the touch panel 10. When the user tries to press the display layer of the display unit 5, the user's finger traverses the contact detecting area first of all, and breaks in a light path 151f. Neither the light receiving X-axis sensor array 151c nor the light receiving Y-axis sensor array 151 receive any light. Hence, the contact detecting unit 21 (shown in FIG. 4) can detect position of the object on the basis of the X and Y coordinates. The contact detecting unit 21 detects strength of the object traversing the contact detecting area (i.e., strength by which the object comes in contact with the display unit 5) and a feature quantity depending upon the strength. Hence, the contact state will be recognized. For instance, when a finger having a certain sectional area passes over a contact detecting area, the infrared ray is blocked by the finger. The number of infrared rays which are blocked per unit time is increased depending upon a speed at which the finger passes the contact detecting area. If the finger is strongly pressed, the finger moves quickly on the contact detecting area. Therefore, it is possible to detect whether or not the finger is pressed strongly depending upon the number of infrared rays which are blocked.

The portable microcomputer is exemplified as the terminal device in the foregoing embodiment. Alternatively, the terminal device may be an electronic data book, a personal digital assistant (PDA), a cellular phone, and so on.

In the flowchart of FIG. 18, the contact position is detected first (step S104), and then the contact strength is detected (step S105). Steps S104 and S105 may be executed in a reversed order. Step S108 (NOTIFYING KEY HITTING), step S109 (INDICATING KEY HITTING) and step S110 (PRODUCING RECOGNITION SOUND) may be executed in a reversed order. The foregoing hold true to the processes shown in FIG. 20.

What is claimed is:

1. An input device comprising:
a display unit indicating an image which represents an input position;
a contact position detecting unit detecting a position of an object brought into contact with a contact detecting surface of the display unit;
a memory storing data representing a difference between the detected position and a center of the image which represents the input position; and
an arithmetic unit calculating an amount for correcting the image which represents the input position on the basis of the data stored by the memory.

2. The input device of claim 1, wherein the contact position detecting unit detects a shape of the object brought into contact with the contact detecting surface, and a display controller is included to indicate on the display unit a profile of the object.

3. The input device of claim 1, wherein the contact position detecting unit detects a shape of the object brought into contact with the contact detecting surface, and a display controller is included to indicate on the display unit a mouse corresponding to the detected profile.

4. The input device of claim 1, wherein the image showing the input position represents a keyboard; and the arithmetic unit calculates a two-dimensional coordinate conversion T which is used to minimize a total difference between U sets of coordinates of a predetermined character string S containing N characters and entered by a user and C′ sets of the center coordinates of the character string S which are obtained by applying the two-dimensional coordinate conversion T to C sets of the center coordinates of the character string S put using a current keyboard layout, the arithmetic unit determining a new keyboard layout on the basis of the C′ sets of the center coordinates.

5. The input device of claim 1, wherein the image showing the input position represents a keyboard; the memory stores data representing a difference between the detected position and a center of the keyboard; and a summing unit is included, and adds up an on the center key hit ratio, or a hit ratio of target keys, on the basis of the data stored in the memory.

6. The input device of claim 1, wherein the image showing the input position represents a keyboard; the memory stores data concerning the number of operations of a delete key, canceled keys, and keys retyped immediately after the delete key; and the arithmetic unit changes a keyboard layout or performs fine adjustment of positions, shapes and angles of keys on the basis of the information related to keys.

7. The input device of claim 6, wherein the arithmetic unit performs the fine adjustment at a predetermined timing.

8. The input device of claim 1 further comprising a correcting unit which corrects the indicated position of the image which represents the input position on the basis of a difference between the contact position and a reference position of the image which represents the input position.

9. The input device of claim 1, wherein the memory stores information for identifying the object on the basis of contact state thereof on the contact detecting surface in correspondence with the correction amount, and the arithmetic unit derives the correction amount on the basis of the object identifying information when the object is contacted.

10. The input device of claim 1 further comprising a contact strength detector which includes first and second bases having electrode layers arranged on opposite surfaces thereof and dot spacers having different levels of height, and detects contact strength of the object brought into contact.

11. A microcomputer comprising:
a display unit indicating an image which represents an input position;
a contact position detecting unit detecting a position of an object brought into contact with a contact detecting surface of the display unit;
a memory storing data representing a difference between the detected position and a center of the image which represents the input position; and
an arithmetic unit calculating an amount for correcting the image which represents the input position on the basis of the data stored by the memory;
a contact position detecting unit detecting a position of an object brought into contact with a contact detecting layer provided on a display layer of the display unit; and
a processing unit which performs processing in accordance with the detected contact state of the object and information entered into the input device.

12. A microcomputer comprising:
a memory storing a difference between a contact position of an object onto a contact detecting surface of a display unit indicating an image which represents an input position and a center of the image which represents the input position;
an arithmetic unit calculating a correction amount of the image which represents the input position on the basis of the data stored in the memory; and
a processing unit which performs processing in accordance with the detected contact state of the object.

13. An information processing method comprising:
indicating an image which represents an input position on a display unit;
detecting a contact position of the object in contact with a contact detecting surface of the display unit;
storing a difference between the detected position and a center of then image which represents the input position;
calculating an amount for correcting the image which represents the input position on the basis of the stored data; and
indicating the corrected image on the display unit.

14. The information processing method of claim 13, wherein the image showing the input position represents a keyboard; and an arithmetic unit calculates a two-dimensional coordinate conversion T which is used to minimize a total difference between U sets of coordinates of a predetermined character string S containing N characters and entered by a user and C′ sets of the center coordinates of the character string S which are obtained by applying the two-dimensional coordinate conversion T to C sets of the center coordinates of the character string S put using a current keyboard layout, the arithmetic unit determining a new keyboard layout on the basis of the C′ sets of the center coordinates.

15. The information processing method of claim 13, wherein the image showing the input position represents a keyboard; a memory stores data representing a difference between the detected position and a center of the keyboard; and a summing unit is included, and adds up an on-center key hit ratio, or a hit ratio of target keys, on the basis of the data stored in the memory.

16. The information processing method of claim 13, wherein the image showing the input position represents a keyboard; a memory stores data concerning the number of operations of a delete key, canceled keys, and keys retyped immediately after the delete key; and an arithmetic unit changes a keyboard layout or performs fine adjustment of positions, shapes and angles of keys on the basis of the information related to keys.

17. An information processing program enabling an input information processor to:
indicate an image which represents an input position on a display unit;
detect a contact position of an object brought into contact on a contact detecting surface of display unit;
store data concerning a difference between the detected position and a center of the image which represents the input position;
calculate an amount for correcting the image which represents the input position on the basis of the stored data; and
indicate the corrected image which represents the input position.

18. The information processing program of claim 17, wherein the image showing the input position represents a keyboard; and an arithmetic unit calculates a two-dimensional coordinate conversion T which is used to minimize a total difference between U sets of coordinates of a predetermined character string S containing N characters and entered by a user and C′ sets of the center coordinates of the character string S which are obtained by applying the two-dimensional coordinate conversion T to C sets of the center coordinates of the character string S put using a current keyboard layout, the arithmetic unit determining a new keyboard layout on the basis of the C′ sets of the center coordinates.

19. The information processing program of claim 17, wherein the image showing the input position represent a keyboard; a memory stores data representing a difference between the detected position and the center of the keyboard; and a summing unit is included, and adds up an on-the center key hit ratio, or a hit ratio of target keys on the basis of the data stored in the memory.

20. The information processing program of claim 17, wherein the image showing the input position represents a keyboard; a memory stores data concerning the number of operations of a delete key, canceled keys, and keys retyped immediately after the delete key; and an arithmetic unit changes a keyboard layout or performs fine adjustment of positions, shapes and angles of keys on the basis of the information related to keys.
